(19) United States
(12) Patent Application Publication
(10) Pub. No.: US 2008/0262183 A1
(43) Pub. Date: Oct. 23, 2008

(54) Dithienopyrrole-containing copolymers

(76) Inventor: Lutz Uwe Lehmann, Seelze (DE)

Correspondence Address: COLLEEN D. SZUCH;Honeywell International Inc. - Patent Department, 101 Columbia Road, Morristown, NJ, 07962, US

(21) Appl. No.: 11/787,708

(22) Filed: Apr. 17, 2007

(51) Int. Cl. C08G 75/06

(52) U.S. Cl. 528/7; 528/360; 528/362; 528/364; 528/378; 528/38; 528/380; 528/9

(57) ABSTRACT

Dithienopyrrole-containing copolymers, and organic semiconductors formed therefrom, used as p-type and donor compounds in semiconductors for organic photovoltaic (OPV) applications, such as solar cells or transistors, such as organic field effect transistors (OFET). Organic semiconductors formed herein have a low bandgap and high absorbance, increasing the efficiency of a transistor or a solar cell. Such dithienopyrrole-containing copolymers also have excellent hole-conductivity which may be even further improved through oxidation.

### BACKGROUND OF THE INVENTION

1. Field of the Invention

The invention relates to dithienopyrrole-containing copolymers and organic semiconductors formed therefrom. More particularly, the invention pertains to dithienopyrrole-containing organic polymeric semiconductors used as p-type, electron donor and hole-conducting compounds respectively in semiconductors for organic photovoltaic (OPV) applications, such as solar cells or transistors, such as organic field effect transistors (OFET).

2. Description of the Related Art

In the 1970s, it was discovered that polymers can be made to conduct electricity like metallic conductors and semiconductors. At the time, plastics were considered non-conductors, but it was discovered that adding impurities to a polymer material could increase its conductivity by more than a billion times. Today, the field of conducting polymers has been greatly expanded to a broad field of commercial applications.

Conducting polymers are finding increased use compared to other conductive materials because they are lightweight, highly processable and have good mechanical properties. Potential applications for conducting polymers include photovoltaics, field-effect transistors, sensors, capacitor coatings, battery electrodes, light-emitting diodes, nonlinear optical materials, molecular wires and molecular switches.

Photovoltaics describes both the technology of solar cells and the creation of electricity that is made possible by solar cells. A solar cell, or photovoltaic cell, is a semiconductor device that converts photons into electricity. This conversion, called the “photovoltaic effect”, is the basic physical process through which a solar cell converts sunlight into electricity. The sun emits photons that contain various amounts of energy corresponding to the different wavelengths of light. Photovoltaic cells convert this energy into electricity through the photogeneration of charge carriers, i.e. electrons and holes, in a light-absorbing material, and separation of the charge carriers. Particularly, when a photovoltaic cell absorbs a photon, the energy of the photon is transferred to an electron in an atom of the cell and the electron is able to escape from its normal position associated with that atom to become part of the current in an electrical circuit. By leaving this position, the electron causes a hole to form. A hole is an unoccupied spot among electrons that are bound in their orbits. Under the application of an electric field, holes move in the opposite direction from electrons, thereby producing an electric current.

Solar cells generally consist of two different types of semiconductors, n-type and p-type, which are typically made of a layered silicon. An n-type semiconductor is a semiconductor in which the density of holes in the valence band is exceeded by the density of electrons in the conduction band. A p-type of semiconductor is a semiconductor in which the density of electrons in the conduction band is exceeded by the density of holes in the valence band. The basic structure formed by the intimate contact of p-type and n-type semiconductors is called a p-n junction. The important characteristic of a p-n junction is that it will conduct electric current with one polarity of applied voltage (forward bias) but will not conduct with the opposite polarity (reverse bias). When p-type semiconductors are put in contact with n-type semiconductors, an electric current will flow if an external force of energy, such as light photons, is applied that is energetic enough to eject electrons from the p-type semiconductor. The force on electrons crossing the p-n junction creates a cell voltage.

As is well known in the art, the efficiencies of solar cells, i.e. the ratio of the electric power output to the light power input, vary widely depending on the type of materials used to produce the cell. The vast majority of solar cells produced worldwide are composed of silicon. Silicon has the advantage of being available in high quantities and can be processed inexpensively by doping with readily available chemical elements, but with relatively low photoconversion efficiencies. However, the most efficient cells are typically not the most economical. For example, solar cells based on materials such as gallium arsenide or indium selenide may be about five times more efficient than cells made from amorphous silicon, but may cost about one hundred times more than an amorphous silicon cell.

In recent years, technological advances have resulted in the development of a new class of organic photovoltaic materials which are based on organic semiconductors. An organic semiconductor is an organic compound that exhibits similar properties to inorganic semiconductors, including the ability to be doped, and the presence of a valence band, conduction band and a band gap, with phonon-assisted hopping contributing to conduction. When charge carriers from the addition or removal of electrons are introduced into the conduction or valence bands, the electrical conductivity increases significantly. By forming a conjugated backbone of continuous overlapping orbitals, a continuous path of overlapping p orbitals is created. This continuous string of orbitals creates degeneracy in the highest occupied molecular orbital (HOMO) and the lowest unoccupied molecular orbital (LUMO), which leads to the filled and unfilled bands that define a semiconductor.

Due to their easy fabrication, mechanical flexibility and relatively low cost, organic semiconductors are attractive as active elements in optoelectronic devices such as organic light emitting diodes (OLED), organic solar cells, organic field effect transistors (OFET), electrochemical transistors and other applications. However, photovoltaic materials formed from conductive polymers are known to have relatively low efficiencies. Current devices formed from n/p-type and donor/acceptor organic polymeric semiconductors in particular have low efficiencies due to loss of energy caused by high bandgaps and poor absorbance. Accordingly, there is an ongoing need in the art for efficient photovoltaic materials that are affordable enough to effectively compete with other energy sources, including fossil fuels.

It has been previously demonstrated that dithienopyrrole homopolymers can be oxidized and reduced without decomposition. However, dithienopyrrole homopolymers have poor film properties at low molecular weights and low solubility in organic solvents at high molecular weights. Applicants have unexpectedly found that dithienopyrrole copolymers overcome these problems when polymerized with a second monomer. More particularly, it has been found that dithienopyrrole-containing copolymers formed from a dithienopyrrole-containing monomer having a substituted pyrrole component have a low bandgap and high absorbance, increasing the efficiency of a transistor or a solar cell. Further, such dithienopyrrole-containing copolymers have excellent hole-conductivity which may be even further improved through oxidation. Accordingly, the polymers of the invention are particularly attractive for the manufacture of affordable, highly efficient organic photovoltaic cells, organic field effect transistors and other organic semiconductors.

### SUMMARY OF THE INVENTION

The invention provides a dithienopyrrole-containing copolymer having the formula:

Y-(D_{f})-[(A)-(D)]ₙ-(A_{g})-Z

wherein D comprises a first monomer radical having the structure:

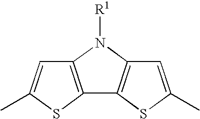

wherein R¹ comprises a C₁ to C₂₀ alkyl group, a C₁ to C₂₀ heteroalkyl group, a C₁ to C₂₀ F-alkyl group, a C₁ to C₂₀ O-alkyl group, a C₁ to C₂₀ S-alkyl group, a C₆ to C₂₀ aryl group or a C₁ to C₂₀ heteroaryl group;

wherein A comprises a second monomer radical different from D which forms a copolymer with D; wherein f and g are 0 or 1;

Y and Z independently comprise hydrogen, a halogen, a C₆ to C₂₀ aryl, a C₁ to C₂₀ heteroaryl, a C₁ to C₂₀ alkyl, a functional group comprising B(OR)(OR′), —COOR, —CONRR′, —CN, —OR, —OCOR, —SCOR, —SCSR, —CSSR, —SO₃R, —SO₃NRR′, —COR, OSO₂R, OSO₃R, —CSR, —NRR′, —NRR′R″⁺, —NRCOR′, —NO, —NO₂, —NCO, —NCS, or a C₆ to C₂₀ aryl with one or more independent functional groups, a C₁ to C₂₀ heteroaryl with one or more independent functional groups, or a C₁ to C₂₀ alkyl with one or more independent functional groups; wherein R, R′ and R″ independently comprise hydrogen, a C₁ to C₂₀ alkyl group, a C₁ to C₂₀ heteroalkyl group, a C₁ to C₂₀ F-alkyl group, a C₆ to C₂₀ aryl group; or a C₁ to C₂₀ heteroaryl group or a counterion forming a salt; and

wherein n is about 1 to about 100.

The invention also provides a dithienopyrrole-containing copolymer having the formula:

V-(Tₗ)ₐ-(D)_{b}-(Tₘ)_{c}-[(Aₚ)-(Tₗ)-(D)-(Tₘ)]ₙ-(Aₚ)_{d}-(Tₗ)ₑ-W

wherein D comprises a first monomer radical having the structure:

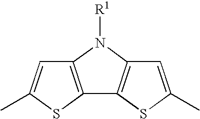

wherein R¹ comprises a C₁ to C₂₀ alkyl group, a C₁ to C₂₀ heteroalkyl group, a C₁ to C₂₀ F-alkyl group, a C₁ to C₂₀ O-alkyl group, a C₁ to C₂₀ S-alkyl group, a C₆ to C₂₀ aryl group or a C₁ to C₂₀ heteroaryl group;

wherein A comprises a second monomer radical different from D which forms a copolymer with D;

wherein each T independently comprises an unsubstituted thiophene monomer radical, a substituted thiophene monomer radical, an unsubstituted thiophene oligomer radical or a substituted thiophene oligomer radical; said substituents comprising one or more hydrogens, C₁ to C₂₀ alkyl groups, C₁ to C₂₀ heteroalkyl groups, C₁ to C₂₀ F-alkyl groups, C₁ to C₂₀ O-alkyl groups, C₁ to C₂₀ S-alkyl groups, C₆ to C₂₀ aryl groups, C₁ to C₂₀ heteroaryl groups or a combination thereof;

V and W independently comprise hydrogen, a halogen, a C₆ to C₂₀ aryl, a C₁ to C₂₀ heteroaryl, a C₁ to C₂₀ alkyl, a functional group comprising B(OR)(OR′), —COOR, —CONRR′, —CN, —OR, —OCOR, —SCOR, —SCSR, —CSSR, —SO₃R, —SO₃NRR′, —COR, OSO₂R, OSO₃R, —CSR, —NRR′, —NRR′R″⁺, —NRCOR′, —NO, —NO₂, —NCO, —NCS, or a C₆ to C₂₀ aryl with one or more independent functional groups, a C₁ to C₂₀ heteroaryl with one or more independent functional groups, or a C₁ to C₂₀ alkyl with one or more independent functional groups; wherein R, R′ and R″ independently comprise hydrogen, a C₁ to C₂₀ alkyl group, a C₁ to C₂₀ heteroalkyl group, a C₁ to C₂₀ F-alkyl group, a C₆ to C₂₀ aryl group; or a C₁ to C₂₀ heteroaryl group or a counterion forming a salt;

wherein a, b, c, d and e are 0 or 1; wherein l, m and p are 0 or 1 and l+m+p=1 or 2 or 3; and wherein n is about 1 to about 100.

The invention further provides a method for forming a dithienopyrrole-containing copolymer having the formula:

Y-(D_{f})-[(A)-(D)]ₙ-(A_{g})-Z

the process comprising:
a) providing a first monomer X¹-D-X², wherein D is a first monomer radical having the structure:

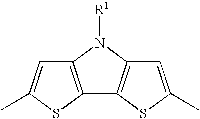

wherein R¹ comprises a C₁ to C₂₀ alkyl group, a C₁ to C₂₀ heteroalkyl group, a C₁ to C₂₀ F-alkyl group, a C₁ to C₂₀ O-alkyl group, a C₁ to C₂₀ S-alkyl group, a C₆ to C₂₀ aryl group or a C₁ to C₂₀ heteroaryl group; and wherein X₁ and X² independently comprise hydrogen, a halogen, a metal leaving group or a non-halogen electron withdrawing group;
b) if X¹ and X² are hydrogen, reacting the first monomer with at least one first reagent, thereby forming an intermediate reaction product, then (c)(I); if X¹ and X² are not hydrogen, then (c)(II);
c) I) if X¹ and X² are hydrogen, reacting the intermediate reaction product with a second monomer radical, A, in the presence of a polymerization catalyst to form a dithienopyrrole-containing copolymer intermediate; or
II) if neither X¹ nor X² are hydrogen, reacting the first monomer with A in the presence of a polymerization catalyst to form a dithienopyrrole-containing copolymer intermediate; and
d) reacting the dithienopyrrole-containing copolymer intermediate with a reaction terminating agent such that Y and Z independently comprise hydrogen, a halogen, a C₆ to C₂₀ aryl, a C₁ to C₂₀ heteroaryl, a C₁ to C₂₀ alkyl, a functional group comprising B(OR)(OR′), —COOR, —CONRR′, —CN, —OR, —OCOR, —SCOR, —SCSR, —CSSR, —SO₃R, —SO₃NRR′, —COR, OSO₂R, OSO₃R, —CSR, —NRR′, —NRR′R″⁺, —NRCOR′, —NO, —NO₂, —NCO, —NCS, or a C₆ to C₂₀ aryl with one or more independent functional groups, a C₁ to C₂₀ heteroaryl with one or more independent functional groups, or a C₁ to C₂₀ alkyl with one or more independent functional groups; wherein R, R′ and R″ independently comprise hydrogen, a C₁ to C₂₀ alkyl group, a C₁ to C₂₀ heteroalkyl group, a C₁ to C₂₀ F-alkyl group, a C₆ to C₂₀ aryl group; or a C₁ to C₂₀ heteroaryl group or a counterion forming a salt; and

wherein f and g are 0 or 1; wherein A is different than said first monomer radical and forms a copolymer with D; and wherein n is about 1 to about 100.

The invention still further provides a method for forming a dithienopyrrole-containing copolymer having the formula:

V-(Tₗ)ₐ-(D)_{b}-(Tₘ)_{c}-[(Aₚ)-(Tₗ)-(D)-(Tₘ)]ₙ-(Aₚ)_{d}-(Tₗ)ₑ-W

the method comprising:
a) I) reacting a first monomer having the formula X¹-D-X² with a second monomer having the formula Y¹-Tₗ-Aₚ-Tₘ-Y² in the presence of a polymerization catalyst to form a dithienopyrrole-containing copolymer intermediate; or
II) reacting a first monomer having the formula X¹-Tₗ-D-Tₘ-X² with a second monomer having the formula Y¹-Aₚ-Y² in the presence of a polymerization catalyst to form a dithienopyrrole-containing copolymer intermediate; or
III) reacting a first monomer having the formula X¹-T_{h′}-D-T_{h″}-X² with a second monomer having the formula Y¹-T_{j′}-Aₚ-T_{j″}-Y² in the presence of a polymerization catalyst to form a dithienopyrrole-containing copolymer intermediate; wherein Tₕ-Tⱼ=Tₗ and Tⱼ-Tₕ=Tₘ where Tₕ is either T_{h′} or T_{h″} and Tⱼ is either T_{j′} or T_{j″};
b) reacting the dithienopyrrole-containing copolymer intermediate with a reaction terminating agent such that V and W independently comprise hydrogen, a halogen, a C₆ to C₂₀ aryl, a C₁ to C₂₀ heteroaryl, a C₁ to C₂₀ alkyl, a functional group comprising B(OR)(OR′), —COOR, —CONRR′, —CN, —OR, —OCOR, —SCOR, —SCSR, —CSSR, —SO₃R, —SO₃NRR′, —COR, OSO₂R, OSO₃R, —CSR, —NRR′, —NRR′R″⁺, —NRCOR′, —NO, —NO₂, —NCO, —NCS, or a C₆ to C₂₀ aryl with one or more independent functional groups, a C₁ to C₂₀ heteroaryl with one or more independent functional groups, or a C₁ to C₂₀ alkyl with one or more independent functional groups; wherein R, R′ and R″ independently comprise hydrogen, a C₁ to C₂₀ alkyl group, a C₁ to C₂₀ heteroalkyl group, a C₁ to C₂₀ F-alkyl group, a C₆ to C₂₀ aryl group; or a C₁ to C₂₀ heteroaryl group or a counterion forming a salt;

wherein:

D is a first monomer radical having the structure:

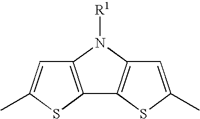

wherein R¹ comprises a C₁ to C₂₀ alkyl group, a C₁ to C₂₀ heteroalkyl group, a C₁ to C₂₀ F-alkyl group, a C₁ to C₂₀ O-alkyl group, a C₁ to C₂₀ S-alkyl group, a C₆ to C₂₀ aryl group or a C₁ to C₂₀ heteroaryl group;

wherein X¹, X², Y¹ and y² independently comprise hydrogen, a halogen, a metal leaving group or a non-halogen electron withdrawing group;

wherein A is a second monomer radical different than D;

wherein each T independently comprises an unsubstituted thiophene monomer radical, a substituted thiophene monomer radical, an unsubstituted thiophene oligomer radical or a substituted thiophene oligomer radical; said substituents comprising one or more hydrogens, C₁ to C₂₀ alkyl groups, C₁ to C₂₀ heteroalkyl groups, C₁ to C₂₀ F-alkyl groups, C₁ to C₂₀ O-alkyl groups, C₁ to C₂₀ S-alkyl groups, C₆ to C₂₀ aryl groups, C₁ to C₂₀ heteroaryl groups or a combination thereof;

wherein a, b, c, d and e are 0 or 1; wherein l, m and p are 0 or 1 and l+m+p=1 or 2 or 3; and wherein n is about 1 to about 100.

Also provided are oxidized dithienopyrrole-containing copolymers as provided above having the formula:

$$Y - ( {D}_{f} ) - {[ ( A ) - ( D ) ]}_{n}^{k ⊕} - ( {A}_{g} ) - Z \cdot \frac{k}{t} {X}^{t ⊖}$$

$$or$$

$$V - {( {T}_{l} )}_{a} - {( D )}_{b} - {( {T}_{m} )}_{c} - {[ ( {A}_{p} ) - ( {T}_{l} ) - ( D ) - ( {T}_{m} ) ]}_{n}^{k ⊕} - {( {A}_{p} )}_{d} - {( {T}_{l} )}_{e} - W \cdot \frac{k}{t} {X}^{t ⊖}$$

wherein X is an anion, wherein t is 1 to 4 and wherein k is 1 to 100.

Also provided are articles formed from the dithienopyrrole-containing copolymers described herein.

### DETAILED DESCRIPTION OF THE INVENTION

The invention provides dithienopyrrole-containing copolymers which are useful for the production of semiconductor devices. More particularly, the invention provides dithienopyrrole-containing copolymers formed by reacting an electron donating dithienopyrrole monomer with an electron accepting monomer.

In a first embodiment, the dithienopyrrole-containing copolymers are most broadly described by the following formula: Y-(D_{f})-[(A)-(D)]ₙ-(A_{g})-Z.

In a second embodiment, the dithienopyrrole-containing copolymers are described by the following formula:

V-(Tₗ)ₐ-(D)_{b}-(Tₘ)_{c}-[(Aₚ)-(Tₗ)-(D)-(Tₘ)]ₙ-(Aₚ)_{d}-(Tₗ)ₑ-W

In each of these embodiments, D comprises a first monomer radical having the structure:

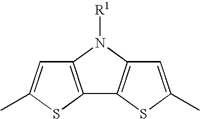

wherein R¹ comprises a C₁ to C₂₀ alkyl group, a C₁ to C₂₀ heteroalkyl group, a C₁ to C₂₀ F-alkyl group, a C₁ to C₂₀ O-alkyl group, a C₁ to C₂₀ S-alkyl group, a C₆ to C₂₀ aryl group or a C₁ to C₂₀ heteroaryl group; A comprises a second monomer radical different from D which forms a copolymer with D; and n is preferably from about 1 to about 100, more preferably from about 5 to about 50 and most preferably from about 10 to about 50. While these ranges for n are preferred, they are not intended to be strictly limiting. Particularly, n may comprise as much as 100,000 or greater. For smaller monomers, n is typically higher than for larger monomers so that for the lower polymer molecular weight limit the larger monomers are typically more relevant and and for the upper limit the smaller monomers are typically more relevant.

In the first embodiment, Y and Z independently are preferably hydrogen, a halogen, a C₆ to C₂₀ aryl, a C₁ to C₂₀ heteroaryl, a C₁ to C₂₀ alkyl, any functional group, e.g. B(OR)(OR′), —COOR, —CONRR′, —CN, —OR, —OCOR, —SCOR, —SCSR, —CSSR, —SO₃R, —SO₃NRR′, —COR, OSO₂R, OSO₃R, —CSR, —NRR′, —NRR′R″⁺, —NRCOR′, —NO, —NO₂, —NCO, —NCS or a C₆ to C₂₀ aryl with one or more independent functional groups, a C₁ to C₂₀ heteroaryl with one or more independent functional groups, or a C₁ to C₂₀ alkyl with one or more independent functional groups; wherein R, R′ and R″ independently comprises hydrogen, a C₁ to C₂₀ alkyl group, a C₁ to C₂₀ heteroalkyl group, a C₁ to C₂₀ F-alkyl group, a C₆ to C₂₀ aryl group; or a C₁ to C₂₀ heteroaryl group or a counterion to form a salt. More preferably, Y and Z independently comprise hydrogen, a halogen, a C₆ to C₂₀ aryl, a C₁ to C₂₀ heteroaryl, a C₁ to C₂₀ alkyl, —B(OR)(OR′), —COOR, —CN, —OR, —SR, —SO₃R, or a C₆ to C₂₀ aryl with one or more independent functional groups, a C₁ to C₂₀ heteroaryl with one or more independent functional groups, or a C₁ to C₂₀ alkyl with one or more independent functional groups, wherein R and R′ independently comprises hydrogen, a C₁ to C₂₀ alkyl group, a C₁ to C₂₀ heteroalkyl group, a C₁ to C₂₀ F-alkyl group, a C₆ to C₂₀ aryl group; or a C₁ to C₂₀ heteroaryl group or a counterion to form a salt. More preferably, Y and Z independently comprise hydrogen, a halogen (preferably Br or Cl), a C₆ to C₂₀ aryl, a C₁ to C₂₀ heteroaryl, a C₁ to C₂₀ alkyl, boronic acid or boronic ester, a C₆ to C₂₀ arylcarboxylic acid or a C₁ to C₂₀ heteroarylcarboxylic acid. Most preferably, Y and Z are independently phenyl, 2-thienyl or 5-carboxy-2-thienyl. Also, f and g are 0 or 1. Also, when f=0 then Y=Z and if g=0 then Z=Y. If f=1 then Y═Y and g=1 then Z=Z. As shown above, Y is linked to D and Z is linked to A, even if Y and Z stand for the same group.

In the second embodiment, each T independently comprises an unsubstituted thiophene monomer radical, a substituted thiophene monomer radical, an unsubstituted thiophene oligomer radical or a substituted thiophene oligomer radical; said substituents comprising one or more hydrogens, C₁ to C₂₀ alkyl groups, C₁ to C₂₀ heteroalkyl groups, C₁ to C₂₀ F-alkyl groups, C₁ to C₂₀ O-alkyl groups, C₁ to C₂₀ S-alkyl groups, C₆ to C₂₀ aryl groups, C₁ to C₂₀ heteroaryl groups or a combination thereof.

In the more preferred embodiments of the invention, each T independently comprises a substituted thiophene monomer radical having the structure:

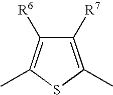

wherein R⁶ and R⁷ independently comprise hydrogen, a C₁ to C₂₀ alkyl group, a C₁ to C₂₀ heteroalkyl group, a C₁ to C₂₀ F-alkyl group, a C₁ to C₂₀ O-alkyl group, a C₁ to C₂₀ S-alkyl group, a C₆ to C₂₀ aryl group or a C₁ to C₂₀ heteroaryl group; or a substituted bithiophene having the structure:

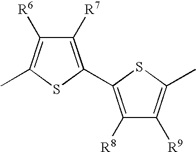

wherein R⁶, R⁷, R⁸ and R⁹ independently comprise hydrogen, a C₁ to C₂₀ alkyl group, a C₁ to C₂₀ heteroalkyl group, a C₁ to C₂₀ F-alkyl group, a C₁ to C₂₀ O-alkyl group, a C₁ to C₂₀ S-alkyl group, a C₆ to C₂₀ aryl group or a C₁ to C₂₀ heteroaryl group;

or a substituted trithiophene having the structure:

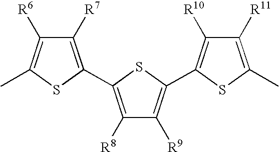

wherein R⁶, R⁷, R⁸, R⁹, R¹⁰ and R¹¹ independently comprise hydrogen, a C₁ to C₂₀ alkyl group, a C₁ to C₂₀ heteroalkyl group, a C₁ to C₂₀ F-alkyl group, a C₁ to C₂₀ O-alkyl group, a C₁ to C₂₀ S-alkyl group, a C₆ to C₂₀ aryl group or a C₁ to C₂₀ heteroaryl group. Most preferably, each T independently comprises an unsubstituted thiophene, a mono-alkyl-substituted thiophene, a dialkyl-substituted bithiophene or a dialkyl-substituted trithiophene

Similar to Y and Z above, in the second embodiment, V and W independently are preferably hydrogen, a halogen, a C₆ to C₂₀ aryl, a C₁ to C₂₀ heteroaryl, a C₁ to C₂₀ alkyl, any functional group, e.g. B(OR)(OR′), —COOR, —CONRR′, —CN, —OR, —OCOR, —SCOR, —SCSR, —CSSR, —SO₃R, —SO₃NRR′, —COR, OSO₂R, OSO₃R, —CSR, —NRR′, —NRR′R″⁺, —NRCOR′, —NO, —NO₂, —NCO, —NCS or a C₆ to C₂₀ aryl with one or more independent functional groups, a C₁ to C₂₀ heteroaryl with one or more independent functional groups, or a C₁ to C₂₀ alkyl with one or more independent functional groups; wherein R, R′ and R″ independently comprises hydrogen, a C₁ to C₂₀ alkyl group, a C₁ to C₂₀ heteroalkyl group, a C₁ to C₂₀ F-alkyl group, a C₆ to C₂₀ aryl group; or a C₁ to C₂₀ heteroaryl group or a counterion to form a salt. More preferably, V and W independently comprise hydrogen, a halogen, a C₆ to C₂₀ aryl, a C₁ to C₂₀ heteroaryl, a C₁ to C₂₀ alkyl, —B(OR)(OR′), —COOR, —CN, —OR, —SR, —SO₃R, or a C₆ to C₂₀ aryl with one or more independent functional groups, a C₁ to C₂₀ heteroaryl with one or more independent functional groups, or a C₁ to C₂₀ alkyl with one or more independent functional groups, wherein R and R′ independently comprises hydrogen, a C₁ to C₂₀ alkyl group, a C₁ to C₂₀ heteroalkyl group, a C₁ to C₂₀ F-alkyl group, a C₆ to C₂₀ aryl group; or a C₁ to C₂₀ heteroaryl group or a counterion to form a salt. More preferably, V and W independently comprise hydrogen, a halogen (preferably Br or Cl), a C₆ to C₂₀ aryl, a C₁ to C₂₀ heteroaryl, a C₁ to C₂₀ alkyl, boronic acid or boronic ester, a C₆ to C₂₀ arylcarboxylic acid or a C₁ to C₂₀ heteroarylcarboxylic acid. Most preferably, V and W are independently phenyl, 2-thienyl or 5-carboxy-2-thienyl.

Also, l, m and p are 0 or 1 and l+m+p=1 or 2 or 3. Any combination of l, m and p is suitable herein as long as not all three are 0. Accordingly, six different combinations are available: where l and p are 1 and m is 0; where m and p are 1 and l is 0; where m and p are 0 and l is 1; where l and p are 0 and m is 1; where l and m are 1 and p is 0; and where each of l, m and p are 1. The following combinations are most preferred: I) each of l, m and p are 1; or II) l and m are 1 and p is 0; or III) m and p are 0 and l is 1.

In each of the embodiments of the invention, second monomer A preferably comprises an arylene or heteroarylene radical. Heteroarylene refers to an aromatic divalent radical of a five to seven member aromatic ring that includes one or more heteroatoms independently selected from S, O, N, and P. That is, a heteroarylene is a divalent radical of a heteroaromatic compound. Such a heteroaromatic ring can be fused to one or more rings and can contain 1 to about 10 other rings selected from another heterocyclic ring(s), heteroaryl ring(s), aryl ring(s), cycloalkenyl ring(s), cycloalkyl rings, and combinations thereof. A heteroarylene typically may contain up to about 60 carbon atoms. Examples of heteroarylene groups include, but are not limited to, divalent radicals of diazine, triazine, thiophene, furane, pyrrole, imidazole, pyrazole, triazole, tetrazole, thiazole, oxazole, isoxazole, oxadiazole, thiadiazole, isothiazole, pyridine, pyridazine, pyrazine, pyrimidine, quinoline, isoquinoline, benzofuran, benzothiophene, indole, carbazole, benzoxazole, benzothiazole, benzoisothiazole, benzimidiazole, cinnoline, quinazoline, quinoxaline, phthalazine, benzothiadiazole, benzotriazine, phenazine, phenanthridine, acridine, indazole, silones, thiadiazoloquinoxaline, thienodiazine, thienothiophene, thienofurane, thienopyrrole, thienoimidazole, thienopyrazole, thienotriazole, thienotetrazole, thienothiazole, thienooxazole, thienoisoxazole, thienooxadiazole, thienothiadiazole, thienoisothiazole, thienopyridine, thienopyridazine, thienopyrazine, thienopyrimidine, dithienothiophene, thienocyclopentane, dithienocyclopentane, thienocyclohexane, dithienocyclohexane.

Specific examples of heteroarylenes include, but are not limited to, furan-2,5-diyl, thiophene-2,4-diyl, 1,3,4-oxadiazole-2,5-diyl, 1,3,4-thiadiazole-2,5-diyl, 1,3-thiazole-2,4-diyl, benzo[1,2,5]thiadiazole-4,7-diyl, 1,3-thiazole-2,5-diyl, pyridine-2,4-diyl, pyridine-2,3-diyl, pyridine-2,5-diyl, pyrimidine-2,4-diyl, quinoline-2,3-diyl, 1,1-dialkyl-1H-silole-2,5-diyl, quinoxaline-5,8-diyl, thieno[3,4-b]pyrazine-5,7-diyl, 2,1,3-benzothiadiazole-4,7-diyl and the like.

Arylene refers to an aromatic divalent radical of a five to seven member aromatic ring. Such an aromatic ring can be fused to one or more rings and can contain 1 to about 10 other rings selected from another cyclic ring(s), aryl ring(s), cycloalkenyl ring(s), cycloalkyl rings, and combinations thereof. An arylene typically may contain up to about 60 carbon atoms. Examples of heteroarylene groups include, but are not limited to, divalent radicals of fluorene, benzene, naphthalene.

With reference to each embodiment of the invention, A more preferably comprises an electron acceptor monomer radical having one of the following structures:

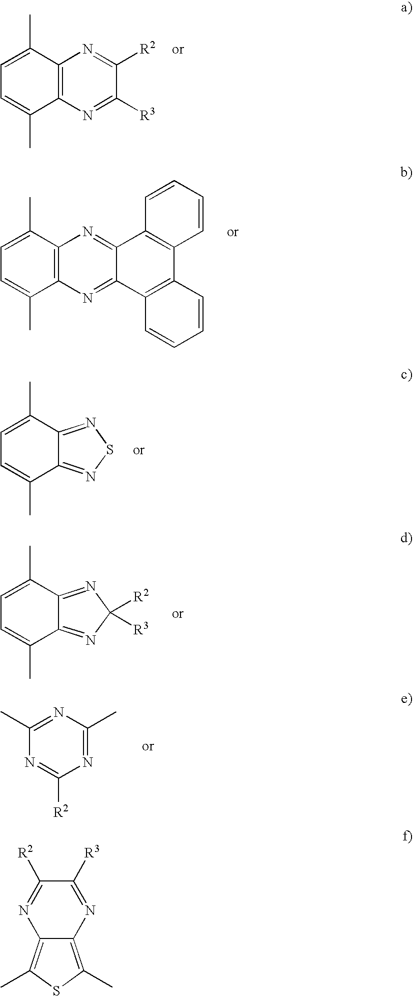

wherein R² and R³ independently comprise hydrogen, a C₁ to C₂₀ alkyl group, a C₁ to C₂₀ heteroalkyl group, a C₁ to C₂₀ cycloalkyl group, a C₁ to C₂₀ F-alkyl group, a C₁ to C₂₀ O-alkyl group, a C₁ to C₂₀ S-alkyl group, a C₆ to C₂₀ aryl group, a C₁ to C₂₀ heteroaryl group, a C₁ to C₂₀ alkyl-substituted C₆ to C₂₀ aryl group or a C₁ to C₂₀ alkoxy-substituted C₆ to C₂₀ aryl group. Of these structures, the most preferred are electron accepting groups, most preferably structures a), c) and f).

More preferably, in each embodiment, A comprises:

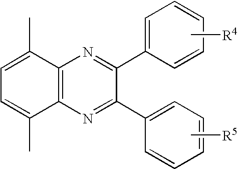

wherein R⁴ and R⁵ independently comprise a C₁ to C₂₀ alkyl group or a C₁ to C₂₀ alkoxy group;

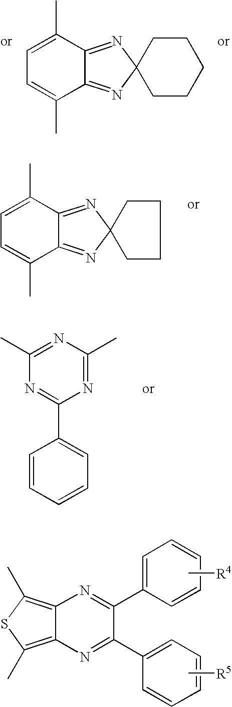

wherein R⁴ and R⁵ independently comprise a C₁ to C₂₀ alkyl group or a C₁ to C₂₀ alkoxy group. Most preferably, A comprises an electron accepting aromatic group such as a benzene group, a thiophene group, a bithiophene group, a benzothiophene group, a furane group or a naphthalene group. In another most preferred embodiment, component A comprises an electron accepting heteroaromatic oligomeric group, such as a bithiophene

With reference to each embodiment of the invention, R¹ preferably comprises a C₁ to C₂₀ alkyl group or a C₆ to C₂₀ aryl group and R², R³, R⁴, R⁵, R⁶, R⁷, R⁸, R⁹, R¹⁰ and R¹¹ preferably comprise hydrogen, a C₁ to C₂₀ alkyl group, a C₆ to C₂₀ aryl group or a C₁ to C₂₀ alkoxy group. The substitutions mainly serve to improve the solubility of the polymer and to adjust HOMO, LUMO and the bandgap respectively. More preferred alkyl groups are butyl (C₄), hexyl (C₆), octyl (C₈), decyl (C₁₀), or dodecyl (C₁₂) groups, as well as substituted alkyl groups such as ethyl-hexyl. More preferred aryl groups are phenyl (C₆) or naphthyl (C₁₀). It is also within the scope of the invention for R groups to comprise an alkyl, aryl or alkoxy groups having greater than C₂₀ (e.g. as high as C₁₀ or more). In all cases, the R₁ group should comprise a group that is non-reactive with the first and second reagents or otherwise must be protected from reacting with either reagent or catalyst, as is well known in the art. Most preferably, R¹ comprises a C₁ to C₂₀ alkyl group because this improves the solubility of the dithienopyrrole-containing copolymers in organic solvents, and R²-R¹¹ are preferably hydrogen or a C₁ to C₂₀ alkyl. For example, some molecules will only have R2 and R3, or R4-R7, or R6-R9, and some of these groups would thereby by hydrogen and some would be alkyl groups, preferably.

Particularly preferred dithienopyrrole-containing copolymers of the invention are polymers of the following structures:

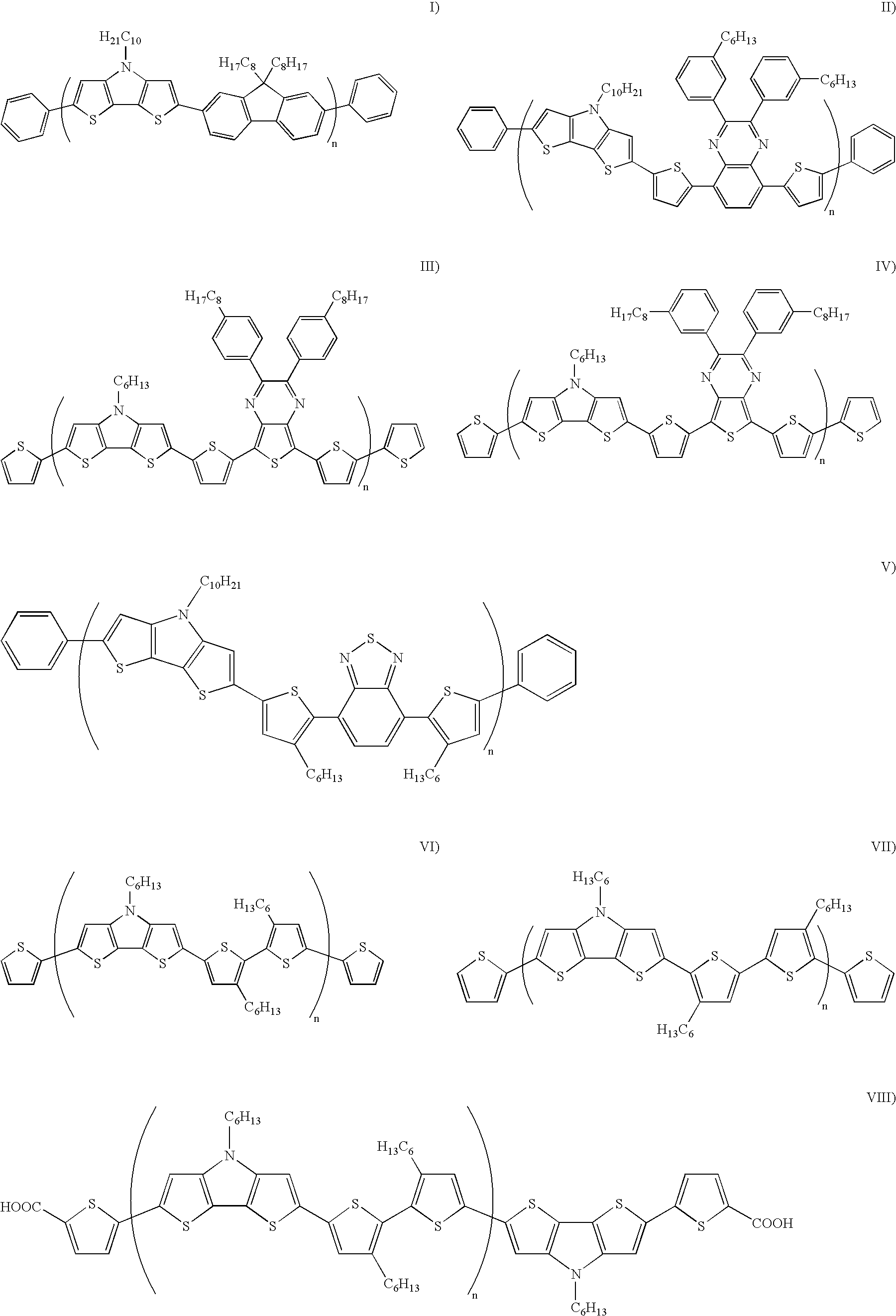

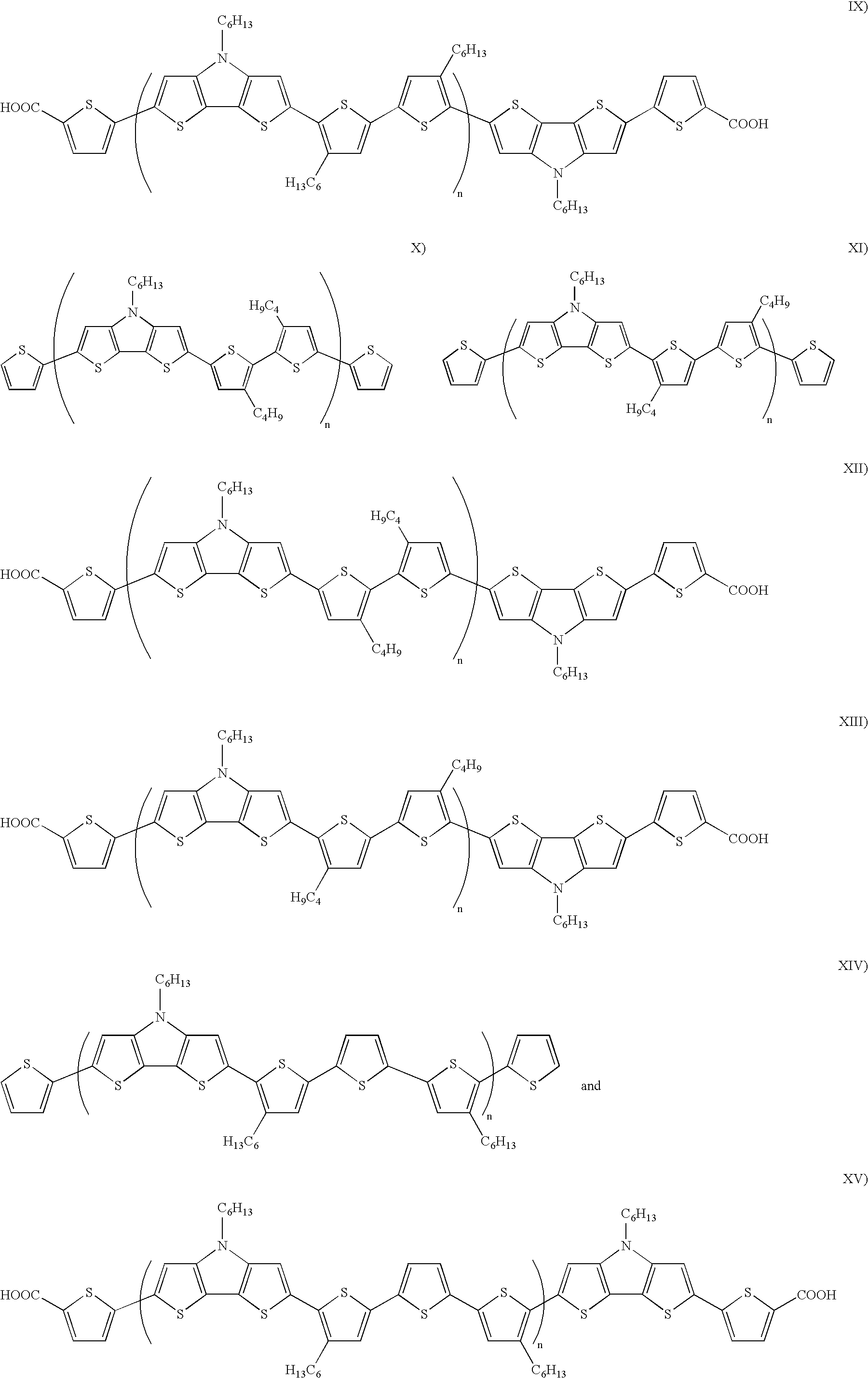

where n is preferably 5-100 for each of these structures.

In the preferred embodiments of the invention, the resulting dithienopyrrole-containing copolymers preferably have a weight average molecular weight of about 1,000 or greater, more preferably from about 5,000 to about 50,000, or even higher as long as the polymer remains soluble in an appropriate solvent, such as tetrahydrofuran (THF) or toluene. The methods of the invention may also be employed to produce lower molecular weight polymers if desired.

There are two general formulas that describe the dithienopyrrole-containing copolymers of the invention and distinct, but similar methods through which such copolymers may be produced. In a first embodiment, a method of the invention produces copolymers having a formula: Y-(D_{f})-[(A)-(D)]ₙ-(A_{g})-Z. In a second embodiment, a method of the invention produces copolymers having a formula: V-(Tₗ)ₐ-(D)_{b}-(Tₘ)_{c}-[(Aₚ)-(Tₗ)-(D)-(Tₘ)]ₙ-(Aₚ)_{d}-(Tₗ)ₑ-W. Each of these copolymer types may be produced via well known reaction mechanisms, such as the Rieke metal approach, the Stille approach, the Suzuki approach, the Hiyama approach or through Kumada reactions with alkylmagnesium Grignard reagents. Other useful approaches not particularly specified here are may be employed, such as the Miyaura borylation reaction. The reaction mechanisms are described with greater detail as follows and in the inventive examples.

In the first embodiment, a dithienopyrrole-containing copolymer having the formula Y-(D_{f})-[(A)-(D)]ₙ-(A_{g})-Z is formed by a method comprising the following steps. First, a first monomer X¹-D-X² is provided wherein D is a first monomer radical with an R¹ substituent as previously defined, and wherein X¹ and X² independently comprise hydrogen, a halogen, a metal leaving group or a non-halogen electron withdrawing group. More particularly, X¹ and X² may independently comprise hydrogen, F, Cl, Br, I, carboxylate ion, tosylate, N═NPh, carboxylic acid, C₆ to C₂₀ F-aryl electron withdrawing groups, such as pentafluorophenyl, C₁ to C₂₀ F-alkyl electron withdrawing groups, such as including trifluoromethyl (CF₃) and other fluorinated organic compounds, NH₃⁺, CN, SO₂Me, nitro, NMe₃⁺, and N₂⁺; carboxylic esters (COOR′), e.g., t-butyl esters, ketones (COR′), OR′, NR′₂, CN, OC(O)R′ or OSO₂R′, wherein R′ comprises a C₁ to C₂₀ alkyl group, a C₁ to C₂₀ heteroalkyl group, a C₁ to C₂₀ F-alkyl group, a C₁ to C₂₀ O-alkyl group, a C₁ to C₂₀ S-alkyl group, a C₆ to C₂₀ aryl group; or a C₆ to C₂₀ heteroaryl group. Useful metal leaving groups non-exclusively include compounds comprising lithium, sodium, potassium, zinc, magnesium, tin, boron containing groups or a combination thereof. Most preferably, X¹ and X² comprise magnesium, tin or boron containing groups, Cl or Br. The next step is dictated by groups X¹ and X². If X¹ and X² are hydrogen, the first monomer is to be reacted with at least one first reagent to form an intermediate reaction product where both X¹ and X² are preferably removed and substituted by a metal leaving group (MRₓ″) that is transferred from said first reagent. For example, suitable first reagents include a Grignard reagent, an organostannane, an organolithium group, an organosodium group, an organopotassium group, an organozinc group, an organoboronic acid or ester, an organosilane or a combination thereof, and said Rₓ″ groups may comprise a C₁ to C₂₀ alkyl group, a C₁ to C₂₀ heteroalkyl group, a C₁ to C₂₀ F-alkyl group, a C₁ to C₂₀ O-alkyl group, a C₁ to C₂₀ S-alkyl group, a C₆ to C₂₀ aryl group a C₆ to C₂₀ heteroaryl group, or a hydroxy group. M comprises Mg, Sn, Li, Na, K, Zn, B or Si and x=0-3. This reaction causes the hydrogens (i.e. X¹ and X²) to disassociate from the first monomer and they are replaced by the MRₓ″ groups.

To illustrate, in a sample reaction (where X¹ and X² are hydrogen):

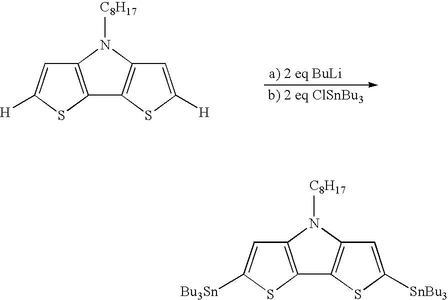

In the most preferred embodiment of the invention, the first reagent comprises the combination of an organo lithium reagent and an organostannylhalide reagent. The organolithium reagent (R′″Li) may generally be any alkyllithium or aryllithium reagent as is known by those skilled in the art. In a first step the hydrogens are replaced by lithium. The intermediate reaction product is obtained by reaction with an organostannyl reagent. The organostannyl reagent (R″″SnX″″) may generally be any alkylstannylhalide or arylstannylhalide reagent as is known by those skilled in the art. X″″ may be any halogen, but is typically Br, Cl or I, and R″″ may comprise an alkyl group having at least one carbon atom or an aryl group having at least six carbon atoms, and preferably comprising a C₁ to C₂₀ alkyl group or C₆ to C₂₀ aryl group. The formation of stannyl reagents are well known in the art. In the preferred embodiment of the invention, the stannyl reagent is prepared using an aprotic organic solvent, preferably tetrahydrofuran. Examples of stannyl reagents suitable herein include a variety of substituted and unsubstituted aryl and alkyl stannyl reagents including methyl, ethyl, isopropyl, butyl, sec-butyl, tert-butyl, t-amyl, t-octyl, hexyl, pentyl, and 1-octyl stannyl halides, such as stannyl bromides and stannyl chlorides. Preferred stannyl reagents include triethylstannylchloride and tributylstannyl chloride. The reaction is preferably carried out at a reaction temperature of from about −78° C. to about 110° C., more preferably from about −78° C. to about 50° C. and most preferably from about −78° C. to about 25° C. The reaction may be carried out for about 1 min to about 1 day, and is typically carried out for about 5 to about 15 hours.

The first monomer is preferably combined with the first reagent at a monomer:reagent ratio of about 1:2-3 eq, more preferably about 1:2.0-2.5 eq and most preferably in a 1:2.0-2.2 eq. ratio. Further, the first reagent is preferably combined with the first monomer in the presence of an organic solvent. The preferred solvent is a non-reactive, dry (anhydrous) ether, diethylether or dry tetrahydrofuran solvent. Particularly, when the first reagent is a lithium, stannyl or Grignard reagent, non-reactive, anhydrous or “dry” solvents are typically required because they are highly reactive with water. In a more preferred embodiment, the solvent is dry THF or 2-methyl-THF. THF and 2-methyl-THF are preferred because they have been found as the most successful solvents for reducing or eliminating the formation of interfering reaction side-products, and allows for the use of higher concentrations of both the reagent and the catalyst. In the preferred embodiment of the invention, the first monomer is present in a solvent in a concentration of about 0.1 mol/L to about 2 mol/L, more preferably about 0.1 mol/L to 1 mol/L, and most preferably about 0.1 mol/L to 0.5 mol/L for reaction with the first reagent to form an intermediate reaction product as described above.

Next, if X¹ and X² were hydrogen in the first monomer, the intermediate reaction product is thereafter reacted with a second monomer radical, A, in the presence of a polymerization catalyst to form a dithienopyrrole-containing copolymer intermediate. Second monomer radical A comprises an electron acceptor as previously defined. Via either polymerization method, second monomer radical A is preferably monosubstituted or disubstituted with one or more halogens, metal leaving groups or non-halogen electron withdrawing groups that leave A during the polymerization reaction. Examples of such substituents are the same as defined above for X¹ and X².

To illustrate, in a sample reaction:

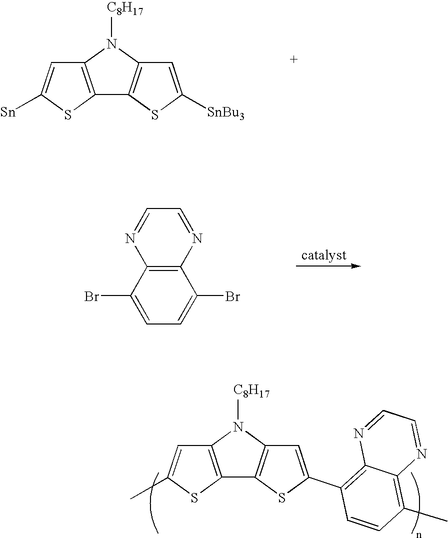

The intermediate reaction product is preferably combined with the second monomer in the presence of an organic solvent. The preferred solvent is an organic solvent, most preferred toluene, THF and 2-methyl-THF. In a more preferred embodiment, the solvent is THF. THF is preferred because it has been found as the most successful solvent for reducing or eliminating the formation of interfering reaction side-products and allows for the use of higher concentrations of both the reagent and the catalyst. In the preferred embodiments of the invention, the intermediate reaction product is combined with the second monomer in an intermediate reaction product:second monomer mol ratio of about 0.2:2.0, more preferably in an equimolar 1:1 ratio. The reaction is preferably carried out at a reaction temperature of from about −20° C. to about 110° C., more preferably from about 0° C. to about 90° C. and most preferably from about 65° C. to about 85° C. The reaction may be carried out for about 1 min to about 7 days, and is typically carried out for about 1 day to about 3 days.

Suitable polymerization catalysts non-exclusively include [1,3-bis(diphenylphosphino)propane]dichloronickel(II), nickel(II) acetylacetonate, 1,2-bis(diphenylphosphino)ethane nickel(II) chloride, dichlorobis(triphenylphosphine) palladium (II), tetrakis(triphenylphosphine) palladium (0), complexes of palladium(II) chloride and tri-tert-butylphosphine, complexes of palladium(II) chloride and 2,2′-bis(diphenylphosphino)-1,1′-binaphthalene, complexes of palladium(II) acetate and tri-tert-butylphosphine, or complexes of or palladium(II) acetate and 2,2′-bis(diphenylphosphino)-1,1′-binaphthalene, complexes of nickel (II) acetylacetonate and tri-tert-butylphosphine, triadamantylphosphine, 1,3-bis(2,4,6-trimethylphenyl)imidazolium chloride, 1,3-bis(2,6-diisopropylphenyl), 1,3-bis(2,6-diisopropylphenyl)imidazolium chloride, 1,3,4-triphenyl-4,5-dihydro-1H-1,2,4-triazol-5-ylidene, 1,3-diadamantyl-imidazolium chloride, 1,3-bis(2,4,6-trimethylphenyl)-imidazolidinium chloride, 1,3-bis(2,6-diisopropylphenyl)-imidazolidinium chloride or suspensions or combinations thereof. In preferred embodiments of the invention, the polymerization catalyst comprises [1,3-bis(diphenylphosphino)propane]dichloronickel(II), dichlorobis(triphenylphosphine) palladium (II) or tetrakis(triphenylphosphine) palladium (0).

If X¹ and X² are not hydrogen, then it is not necessary to react D with a first reagent because the first monomer radical already includes substituent groups suitable for polymerization with second monomer radical A. Accordingly, when neither X¹ nor X² are hydrogen, the first monomer is directly reacted with A in the presence of a polymerization catalyst to form a dithienopyrrole-containing copolymer intermediate.

To illustrate, in a sample reaction (where X¹ and X² are not hydrogen):

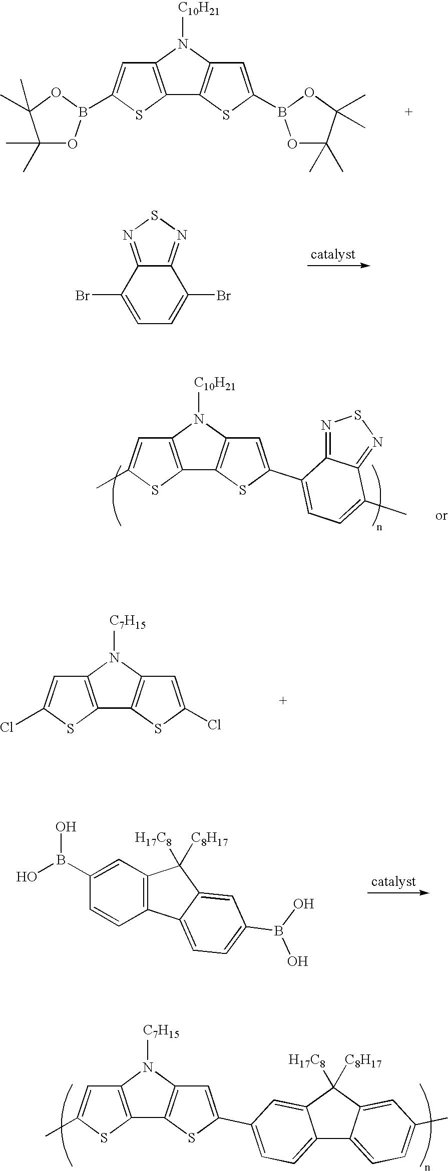

In the preferred embodiments of the invention, the first monomer is combined with the second monomer in an first monomer:second monomer mol ratio of about 0.2:2.0, more preferably in an equimolar 1:1 ratio. The reaction is preferably carried out at a reaction temperature of from about −20° C. to about 110° C., more preferably from about 0° C. to about 90° C. and most preferably from about 65° C. to about 85° C. The reaction may be carried out for about 1 min to about 7 days, and is typically carried out for about 1 day to about 3 days.

Thereafter, the resulting dithienopyrrole-containing copolymer intermediate produced via either route is further reacted with a reaction terminating agent such that Y and Z end groups are as defined previously. Suitable reaction terminating agents would be readily determined by one skilled in the art. Most preferably, the resulting dithienopyrrole-containing copolymer intermediate produced via either route is further reacted with a reaction terminating agent as follows to produce polymers having the following defined end groups Y and Z:
I) reacting the dithienopyrrole-containing copolymer intermediate with compounds Y—X³ and/or Z-X⁴ in the presence of a polymerization catalyst for Y and Z to be a C₆ to C₂₀ aryl, a C₁ to C₂₀ heteroaryl, a C₁ to C₂₀ alkyl, a C₆ to C₂₀ arylcarboxylic acid or a C₁ to C₂₀ heteroarylcarboxylic acid, wherein X³ and X⁴ independently comprise a halogen, a metal leaving group or a non-halogen electron withdrawing group; or
II) reacting the dithienopyrrole-containing copolymer intermediate with acid, or with water, or with both acid and water for Y and Z to be hydrogen, a halogen, boronic acid, boronic ester;

Useful acids include, for example, acetic acid, hydrochloric acid and sulfuric acid. In general, the typical procedure is to react a diboronic acid ester with a dibromide, so the polymer intermediate could have boronic acid ester groups or bromine as end groups. The final reaction step will replace these groups. Typically, a thiophenemonoboronic acid ester is added first, followed by monobromothiophene. The result is that the standard end groups are thiophene (i.e. procedure I). Acid/water typically will only be used in case of the use of a dimetallated compound like a distannylcompound. In that case, a water/acid mixture will remove the stannyl groups, so that the end group will be hydrogen. In general also boronic acid groups can be removed this way.

Y and Z are introduced to the polymer mixture with different leaving groups so that as described above Y will always be linked to D and Z to A. These reactions are preferably conducted at a copolymer intermediate:reactant molar ratio of 1:1-10, more preferably in a 1:2 ratio. These reactions are preferably carried out at a reaction temperature of from about −20° C. to about 110° C., more preferably from about 0° C. to about 100° C. and most preferably from about 20° C. to about 100° C. The reaction may be carried out for about 1 min to about 20 hours, and is typically carried out for about 10 min to about 2 hours. An illustrative reaction example is described below in Example 5.

This final reaction step produces a dithienopyrrole-containing copolymer having the formula: Y-(D_{f})-[(A)-(D)]ₙ-(A_{g})-Z wherein the Y and Z end groups may be tailored to meet the needs of the manufacturer, such as to adjust solubility and crystallinity, to improve the precipitation behavior and/or to introduce anchor groups for application. It should be understood that while the various choices outlined above reflect the preferred embodiments of the invention, certain embodiments are even more preferred. Particularly, in the most preferred embodiment of the invention, groups X¹ and X² of monomer D are boron containing groups, particularly 4,4,5,5-tetramethyl-1,3,2-dioxaborolane-2-yl, 1,3,2-dioxaborinane-2-yl or boronic acid, and group R¹ of monomer D is most preferably an alkyl group, i.e., D most preferably comprises dithienopyrrolebis(dioxaborolane); and most preferably A is a dibromide electron acceptor monomer radical, particularly dibromothienopyrazine.

Each of the above-described polymerization reaction mechanisms for forming the dithienopyrrole-containing copolymers of the invention are well known in the art and may involve a one-step or multi-step reaction which is typically determined by the type of leaving groups attached to the monomers. As is known in the art, depending on the existing leaving groups of the monomer, it may be necessary to react the first monomer or second monomer with a magnesium or lithium source, such as a magnesium metal or a magnesium halide, or butyl lithium, to attach magnesium or lithium to an electron withdrawing group, such as a halogen, prior to reacting the first monomer with the first reagent/second monomer or the second monomer with the first monomer/intermediate reaction product (“IRP”). Thereafter, the magnesium or lithium substituted compound may be further reacted with another reagent to attach a leaving group such as a magnesium-halide, an organostannane (e.g. SnR′₃), sodium, potassium, an organozinc group, an organoboronic acid group (e.g. B(OR′)₂), an organosilane (e.g. SiR′₃), wherein R′ comprises an alkyl group. The methods by which such reactions may be carried out are well known in the art.

Alternately, prior to reaction with a first reagent or with the second monomer, first monomer radical D (or second monomer radical A prior to reaction with the first monomer or IRP) may need to be reacted with a halogenation agent to attach a halogen leaving group to the compound, as is well known in the art. For example, a monomer may be brominated by reacting it with a bromination agent such as N-bromo succinimide (NBS), Br₂, bromide/hydrogen peroxide or 1,2-dibromo-5,5-dimethylhydantoine, chlorinated with a chlorination agent such as N-chlorosuccinimide or fluorinating with a reagent such as N-fluorobenzene-sulfonimide (NFSI) or Selectfluor® (commercially available from Air Products and Chemicals, Inc. of Allentown, Pa.). Bromination is preferred because of bromine groups allow for relatively simple processing.

In a further alternate reaction mechanism for preparing the monomers of the invention for reaction, the monomer may be reacted with a zinc reagent, attaching highly reactive zinc to an existing halogen group on the monomer, if present. The reaction mechanism for attaching such a highly reactive zinc, known in the art as “Rieke zinc”, is the commonly known Rieke metal approach. The method is preferably conducted wherein the halogen is bromine. All of these processes are well known in the art.

In each of the methods described herein, the polymerization catalyst may be added to a separate container which contains the monomers or each of the reactants may be combined in a single step. In the preferred embodiment of the invention, the catalysts are added separately. The catalysts may be added by themselves or in combination with a solvent. Preferably, the catalysts are prepared in the presence of a tetrahydrofuran solvent (e.g. dry THF), more preferably a methyl-tetrahydrofuran solvent, most preferably a 2-methyl-THF solvent. In another alternate embodiment, the catalysts may be generated in-situ during the reaction process using well known techniques.

When either catalyst is present in a solvent, the catalyst compound preferably comprises a catalyst concentration of from about 0.01% by weight to about 10.0% by weight, more preferably 0.1% by weight to about 2% by weight in the solvent. Preferably, the catalyst is combined in a catalyst:second monomer mol ratio of from about 0.1 mol % to about 5 mol %, more preferably from about 0.5 to about 2 mol %. These reaction conditions also apply to the second embodiment below.

In the second embodiment, a dithienopyrrole-containing copolymer having the formula V-(Tₗ)ₐ-(D)_{b}-(Tₘ)_{c}-[(Aₚ)-(Tₗ)-(D)-(Tₘ)]ₙ-(Aₚ)_{d}-(Tₗ)ₑ-W is formed by a method comprising the following steps. First, a first monomer having the formula X¹-D-X² is provided wherein D is a first monomer radical with an R¹ substituent as previously defined, and wherein X¹ and X² are also as previously defined. This first monomer is reacted with a second monomer having the formula Y¹-Tₗ-Aₚ-Tₘ-Y² in the presence of a polymerization catalyst to form a dithienopyrrole-containing copolymer intermediate (option I). As set forth herein, Y¹-Tₗ-Aₚ-Tₘ-Y² is a disubstituted monomer with thiophene substituents Tₗ and Tₘ and end groups Y¹ and Y². Thiophene substituents Tₗ and Tₘ are similar to T defined above and each may independently comprise an unsubstituted thiophene monomer radical, a substituted thiophene monomer radical, an unsubstituted thiophene oligomer radical or a substituted thiophene oligomer radical, said substituents comprising one or more hydrogens, C₁ to C₂₀ alkyl groups, C₁ to C₂₀ heteroalkyl groups, C₁ to C₂₀ F-alkyl groups, C₁ to C₂₀ O-alkyl groups, C₁ to C₂₀ S-alkyl groups, C₆ to C₂₀ aryl groups, C₁ to C₂₀ heteroaryl groups or a combination thereof. Preferred and most preferred Tₗ and Tₘ groups are those previously described as T. End groups Y¹ and Y² independently comprise hydrogen, a halogen, a metal leaving group or a non-halogen electron withdrawing group which may be selected from the materials listed previously for X¹ and X² for the first process method. Most preferably, Y¹ and Y² comprise Br or Cl and R′ preferably comprises a C₁ to C₂₀ alkyl group or a C₆ to C₂₀ aryl group. Aₚ is the same as the monomer radical previously defined as A, and p is defined below. Also, a,b,c,d and e are 0 or 1; and l,m and p are 0 or 1 and l+m+p=1 or 2 or 3. In the preferred embodiments, the most preferred combinations for l, m and p are: I) each of l, m and p are 1; or II) l and m are 1 and p is 0; or III) m and p are 0 and l is 1. Suitable polymerization catalysts include those previously listed.

Alternately, a first monomer having the formula X¹-Tₗ-D-Tₘ-X² is reacted with a second monomer having the formula Y¹-Aₚ-Y² in the presence of a polymerization catalyst to form a dithienopyrrole-containing copolymer intermediate, where X¹, X², Y¹, Y², Tₗ, Tₘ, D and Aₚ are each as previously defined (option II). In another alternate option, a first monomer having the formula X¹-T_{h′}-D-T_{h″}-X² is reacted with a second monomer having the formula Y¹-T_{j′}-Aₚ-T_{j″}-Y² in the presence of a polymerization catalyst to form a dithienopyrrole-containing copolymer intermediate, where X¹, X², Y¹, Y², D and Aₚ are each as previously defined (option III). T_{h′}, T_{h″}, T_{j′} and T_{j″} are thiophene substituents are similar to T defined above. Preferred and most preferred T_{h′}, T_{h″}, T_{j′} and T_{j″} groups are those previously described for groups Tₗ and Tₘ whereby each h and j will each be 0 or 1. In option III only, Tₗ and Tₘ would be dithiophenes wherein Tₕ-Tⱼ=Tₗ and Tⱼ-Tₕ=Tₘ; (where each Tₕ is either T_{h′} or T_{h″} and each Tⱼ is either T_{j′} or T_{j″} giving four different theoretical combinations for each of Tₗ and Tₘ, i.e. Tₗ=j′-h′ or j′-h″ or j″-h′ or j″-h″ and Tₘ=h′j′ or h′-j″ or h″j′ or h″-j″) because Tₗ and Tₘ would be formed by combination of each Tₕ and Tⱼ (i.e. the polymer unit -[(Aₚ)-(Tₗ)-(D)-(Tₘ)]ₙ would also be described as -[(Aₚ)-Tⱼ-Tₕ-D-Tₕ-Tⱼ)]ₙ-. In reality there would only be one combination for Tₘ and one for Tₗ due to the different reactivities of the different groups h′, h″, j′and j″ in combination with the leaving groups. Accordingly, in other perspectives for Option I and Option II, the unit -[(Aₚ)-(Tₗ)-(D)-(Tₘ)]ₙ- could thus be described as -[(Aₚ)-Tⱼ-Tₕ-D-Tₕ-Tⱼ )]ₙ-, where in Option I, each h=0, and in Option II, each j=0.

Preferably, n is about 1 to about 100, more preferably n is from about 5 to about 50 and most preferably n is from about 10 to about 50. While these ranges for n are preferred, they are not intended to be strictly limiting. Particularly, n may comprise as much as 100,000 or greater.

In the preferred embodiments of the invention, the first monomer is combined with the second monomer in an first monomer:second monomer mol ratio of about 0.2:2.0, more preferably in an equimolar 1:1 ratio. These reactions are preferably carried out at a reaction temperature of from about −20° C. to about 110° C., more preferably from about 0° C. to about 90° C. and most preferably from about 65° C. to about 85° C. The reaction may be carried out for about 1 min to about 7 days, and is typically carried out for about 1 day to about 3 days. As above, when the catalyst is present in a solvent, the catalyst compound preferably comprises a catalyst concentration of from about 0.01% by weight to about 10.0% by weight, more preferably 0.1% by weight to about 2% by weight in the solvent. Preferably, the catalyst is combined in a catalyst:second monomer mol ratio of from about 0.1 mol % to about 5 mol %, more preferably from about 0.5 to about 2 mol %.

These reactions are illustrate as follows:

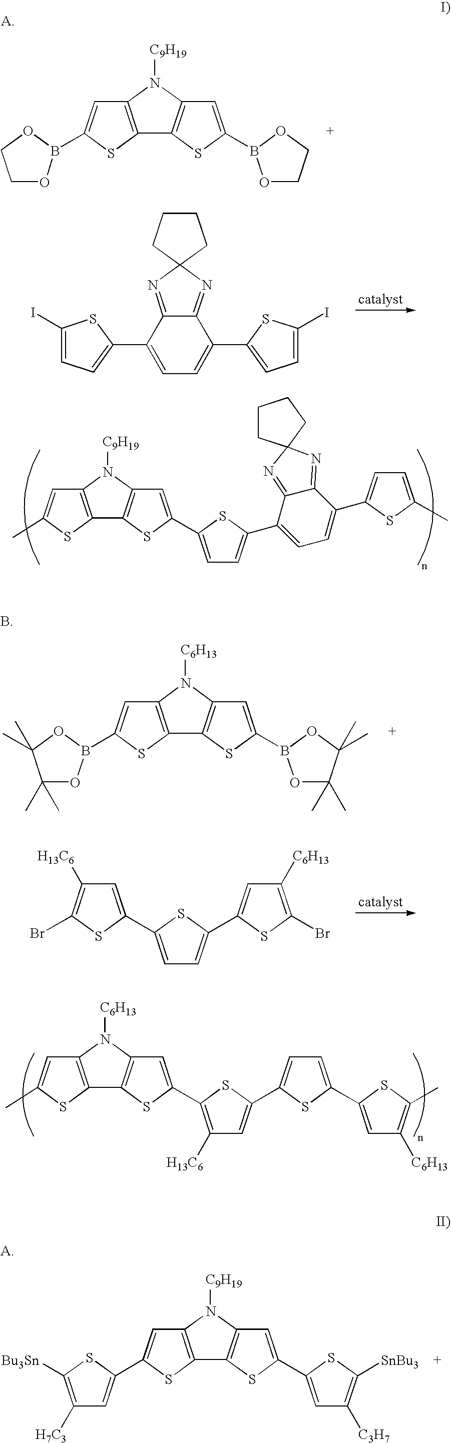

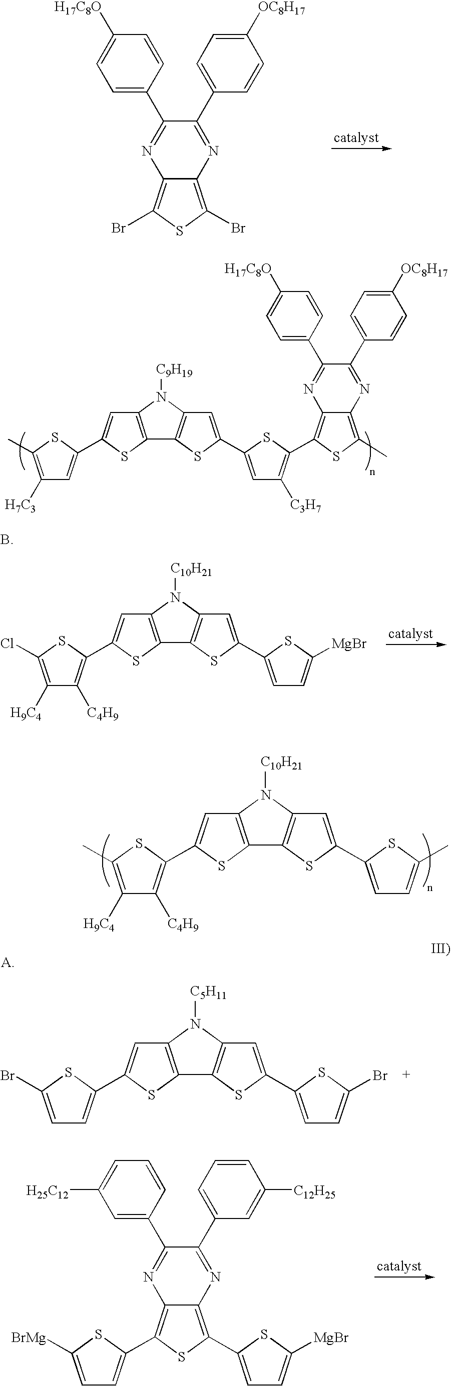

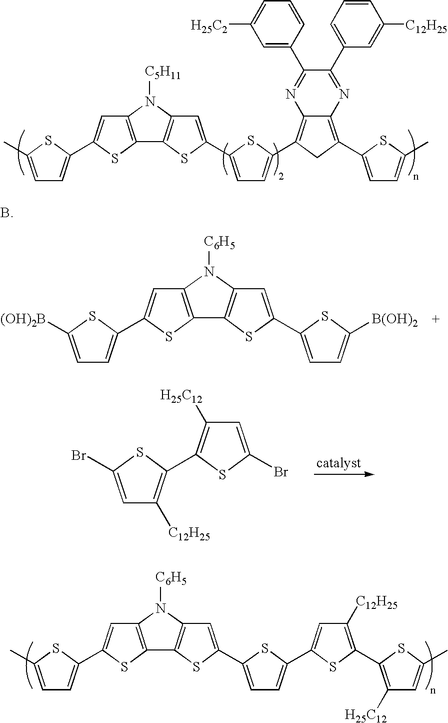

Thereafter, the resulting dithienopyrrole-containing copolymer intermediate produced via either route is further reacted with a reaction terminating agent such that V and W end groups are as defined previously. Suitable reaction terminating agents would be readily determined by one skilled in the art. Most preferably, the resulting dithienopyrrole-containing copolymer intermediate produced via either route is further reacted with a reaction terminating agent as follows to produce polymers having the following defined end groups V and W:
I) reacting the dithienopyrrole-containing copolymer intermediate with compounds V—X³ and/or W—X⁴ in the presence of a polymerization catalyst for V and W to be a C₆ to C₂₀ aryl, a C₁ to C₂₀ heteroaryl, a C₁ to C₂₀ alkyl, a C₆ to C₂₀ arylcarboxylic acid or a C₁ to C₂₀ heteroarylcarboxylic acid; wherein X³ and X⁴ independently comprise a halogen, a metal leaving group or a non-halogen electron withdrawing group;

or
II) reacting the dithienopyrrole-containing copolymer intermediate with acid, or with water, or with both acid and water, for V and W to be hydrogen, a halogen, boronic acid or boronic ester;

the typical procedure is to react a diboronic acid ester with a dibromide, so the polymer intermediate could have boronic acid ester groups or bromine as end groups. The final reaction step will replace these groups. Typically, a thiophenemonoboronic acid ester is added first, followed by monobromothiophene. The result is that the standard end groups are thiophene (i.e. procedure I). Acid/water typically will only be used in case of the use of a dimetallated compound like a distannylcompound. In that case, a water/acid mixture will remove the stannyl groups, so that the end group will be hydrogen. In general also boronic acid groups can be removed this way. These reactions are preferably conducted at a copolymer intermediate:reactant molar ratio of 1:1 to 1:5, more preferably a 1:1 to 1:2 ratio. These reactions are preferably carried out at a reaction temperature of from about −20° C. to about 110° C., more preferably from about 0° C. to about 90° C. and most preferably from about 20° C. to about 85° C. The reaction may be carried out for about 1 min to about 20 hours, and is typically carried out for about 10 min to about 2 hours. An illustrative reaction example is described below in Example 5.

This final reaction step produces a dithienopyrrole-containing copolymers having the formula: V-(Tₗ)ₐ-(D)_{b}-(Tₘ)_{c}-[(Aₚ)-(Tₗ)-(D)-(Tₘ)]ₙ-(Aₚ)_{d}-(Tₗ)ₑ-W wherein the V and W end groups may be tailored to meet the needs of the manufacturer as previously described. It should be understood that while the various choices outlined above reflect the preferred embodiments of the invention, certain embodiments are even more preferred. Particularly, in the most preferred embodiment of the invention, groups X¹ and X² of monomer D are boron containing groups, particularly 4,4,5,5-tetramethyl-1,3,2-dioxaborolane-2-yl, 1,3,2-dioxaborinane-2-yl or boronic acid, and group R¹ of monomer D is most preferably an alkyl group, i.e., D most preferably comprises dithienopyrrolebis(dioxaborolane); and most preferably A is a dibromide electron acceptor monomer radical, particularly dibromothienopyrazine.

In further embodiments of the invention, any of the dithienopyrrole-containing copolymer products described herein may be oxidized by reacting said copolymers with an oxidizing agent. Suitable oxidizing agents non-exclusively include iodine, bromine, chlorine, fluorine, hydrogen peroxide, oxygen, ozone, tert-butylhydroperoxide, 3-chloroperoxybenzoic acid, peroxybenzoic acid, oxalyl chloride, peracetic acid, trifluoroperacetic acid, periodic acid, formic acid, sodium hypochlorite, sodium periodate, osmium tetroxide, sodium perborate, sodium percarbonate, ferric nitrate, manganese dioxide, potassium peroxodisulfate, potassium peroxomonosulfate, potassium permanganate as well as anodic oxidation. A more preferred oxidation agent is iodine. Also more preferred is anodic oxidation. The oxidizing agent is added to a solution of the copolymer and the mixture is stirred for about 1 min to about 10 hrs at about 0 to about 100° C. The amount of oxidizing agent in said solution is preferably about 0.0001 mol % to about 500 mol %, more preferably about 0.1 mol % to about 20 mol %, more preferably about 0.1 mol % to about 10 mol % and most preferably about 1 mol % to about 5 mol %. The reaction will consume the oxidizing agent and the amount of agent used will depend on the reactivity of the agent. For example, iodine is less reactive than other agents and more must be used. Preferably the oxidation reaction achieves only a partial oxidation of the dithienopyrrole-containing copolymers of the invention. Preferably the oxidized copolymers are about 1 mol % to about 20 mol % oxidized.

The oxidation of a dithienopyrrole-containing copolymer having the formula Y-(D_{f})-[(A)-(D)]ₙ-(A_{g})-Z will produce an oxidized dithienopyrrole-containing copolymer having the formula:

$$Y - ( {D}_{f} ) - {[ ( A ) - ( D ) ]}_{n}^{k ⊕} - ( {A}_{g} ) - Z \cdot \frac{k}{t} {X}^{t ⊖}$$

wherein X is an anion such as I⁻, I₃⁻, Cl⁻, Br⁻, F⁻, SO₄²⁻, S²⁻, HS⁻, CO₃²⁻, OH⁻, O₂⁻, O²⁻, NO₃⁻, CH₃COO⁻, CF₃COO⁻, C₆H₅COO⁻ or 3-ClC₆H₅COO⁻, wherein t is 1 to 4 and wherein k is 1 to 100, more preferably t is 1 and more preferably k is 1 to 20.

The oxidation of a dithienopyrrole-containing copolymer having the formula V-(Tₗ)ₐ-(D)_{b}-(Tₘ)_{c}-[(Aₚ)-(Tₗ)-(D)-(Tₘ)]ₙ-(Aₚ)_{d}-(Tₗ)ₑ-W will produce an oxidized dithienopyrrole-containing copolymer having the formula:

$$V - {( {T}_{l} )}_{a} - {( D )}_{b} - {( {T}_{m} )}_{c} - {[ ( {A}_{p} ) - ( {T}_{l} ) - ( D ) - ( {T}_{m} ) ]}_{n}^{k ⊕} - {( {A}_{p} )}_{d} - {( {T}_{l} )}_{e} - W \cdot \frac{k}{t} {X}^{t ⊖}$$

wherein X is an anion as listed above and wherein t is 1 to 4 and k is 1 to 100, more preferably t is 1 and more preferably k is 1-20.

As stated above, the materials of the present invention have been found to be extremely attractive for use as conductive polymers and films useful in the production of conductive articles including electrical and optical devices such as organic field-effect transistors, solar cells or other semiconductors. Films and articles may be formed using techniques that are well known in the art. One well known method for forming a film is extrusion. In a typical extrusion process, the polymeric material for each individual film layer is fed into infeed hoppers of one or more extruders, each extruder handling the material for one or more layers. A melted and plasticated polymer stream from individual extruders is fed into a single manifold co-extrusion die. If forming a single layer film, a single layer of polymer material will emerge from the die. If forming a multilayer film, multiple layers are juxtaposed while in the die and combined, then emerge from the die as a single multiple layer film of polymeric material. After exiting the die, the film is cast onto a first controlled temperature casting roll, passes around the first roll, and then onto a second controlled temperature roll, which is normally cooler than the first roll. The controlled temperature rolls largely control the rate of cooling of the film after it exits the die. Additional rolls may be employed. Processes of coextrusion to form film and sheet laminates are generally known. Typical coextrusion techniques are described in U.S. Pat. Nos. 5,139,878 and 4,677,017. The dithienopyrrole-containing copolymer materials may also be formed into pellets and stored for future use and/or sale.

Dithienopyrrole-copolymers can be used as light-absorbing and hole-conducting compounds in bulk heterojunction solar cells or as hole-conducting compounds in quantum dot solar cells, as well as in dye-sensitized solar cells, in transistors or in any other device as semiconductors. Organic solar cells are prepared as sandwich devices. A hole conductor, e.g. poly(3,4-ethylenedioxythiophene)-poly(styrenesulfonate) (PEDOT:PSS), is doctor-bladed, printed, coated or spin-coated from a solution on a pre-cleaned, patterned electrode/support substrate, e.g. indium tin oxide (ITO) on glass or polymer/plastic foil, e.g. polyethyleneterephthalate (PET), forming a hole-conductor layer. A mixture of the materials of the present invention and an acceptor material, e.g. 1-(3-methoxycarbonyl)-propyl-1-phenyl-(6,6) C₆₁ (PCBM), is dissolved in an organic solvent to form a solution and the solution is doctor-bladed, printed, coated or spin-coated on top of the hole-conductor-layer. The devices are finalized by the deposition of a top electrode, e.g. deposition of a lithium fluoride layer first, followed by deposition of an aluminum layer. This kind of solar cell is called a bulk heterojunction cell as n-type and p-type material or donor (materials of the present invention) and acceptor (e.g. PCBM) material, respectively, are present as a mixture in one layer. Instead of using a blend of the materials of the present invention and PCBM, both compounds can also be dissolved separately in an organic solvent and doctor-bladed, printed, coated or spin-coated to give two separate layers. Quantum Dot solar cells and dye-sensitized solar cells are also prepared as sandwich devices. An electron conductor, e.g. titanium dioxide nanoparticles, is deposited on an electrode forming an electron-conductor layer. A dye is dissolved in an organic solvent to form a solution and the solution is doctor-bladed, printed, coated or spin-coated on top of the electron-conductor-layer forming a light-absorbing layer. A hole-conductor, e.g. materials of the present invention, is dissolved in an organic solvent to form a solution and the solution is doctor-bladed, printed, coated or spin-coated on top of the light-absorbing layer. The device is finalized by the deposition of a top electrode. For quantum dot solar cells quantum dots, e.g. cadmium selenide, are used instead of a dye. Typical organic solar cells and the typical manufacturing techniques are described in “Organic Photovoltaics, Mechanisms, Materials and Devices” edited by Sam-Shajing Sun and Niyazi Serdar Sariciftci, CRC press, ISBN 0-8247-5963-X, M. C. Scharber et al., Advanced Materials 2006, 789-794, and U.S. patent application no. 2006/0141662, the disclosure of which is incorporated herein by reference.

The typical manufacturing process for organic field effect transistors (OFET) is described in U.S. patent application Ser. No. 10/545,361 (publication no. 2006/0131561) and U.S. patent application Ser. No. 11/330,472 (publication no. 2006/0138406), the disclosures of which are incorporated herein by reference, and M. Shkunov et al., Advanced Materials 2005, 2608-2612. The materials of the present invention are incorporated in the devices according to the process described for the organic solar cells.

The polymers, films and articles formed from the processes of the invention have excellent charge carrier mobility (μ), current modulation (on/off ratio) and threshold voltage. Particularly, the polymers, films and articles formed from the processes of the invention have a preferred mobility of at least about 1×10⁻³ cm²/Vs and an on/off ratio of at least about1×10³. However, these charge carrier mobility and current modulation (on/off ratio) numbers, and those in the examples below, apply to the crude assay of the reaction product and the mobility and on/off ratio of a final product can be significantly increased through treatment, e.g. extraction or heat treatment, to mobility levels of 0.05-0.1 cm²/Vs or greater and on/off ratios of 1×10⁵-1×10⁶ or greater. Additional treatments (e.g. treatment with solvents) may be conducted after extraction to further improve the conductivity properties of the reaction product.

The following non-limiting examples serve to illustrate the invention.

### EXAMPLE 1

Two (4-alkyl-4H-dithieno[3,2-b:2′,3′-d]pyrrole-2,6-diyl)-bis-(4,4,5,5-tetramethyl-1,3,2-dioxaborolane) precursors were produced as follows:

To a solution of 2 mmol N-alkyldithienopyrrole in 20 ml tetrahydrofurane was added 4.4 mmol n-butyllithium (1.6 M solution in n-hexane) at −78° C. After stirring for 3 hrs at −78° C. the mixture was warmed to 0° C., stirred for 15 min and cooled down again to −78° C. 12 mmol 2-isopropoxy-4,4,5,5-tetramethyl-1,3,2-dioxaborolane were added and the mixture was allowed to warm to 20° C. overnight. Stirring was continued for 24 hrs. 1 ml acetic acid was then added, followed by 20 ml water and 20 ml toluene. The layers (water and organic layer; organic layer=toluene, hexane, THF or a mixture thereof) were separated and the organic layer was extracted three times with 20 ml 0.1 M hydrochloric acid. The organic layer was dried with magnesium sulfate, filtered and the solvent was removed in vacuum. The product was purified by column chromatography, recrystallized or used without further purification.

General procedure:

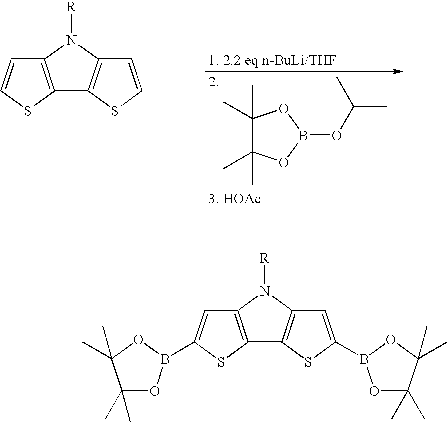

Precursor Compound 1 (R=decyl):

yield: 80%; 1H-NMR (DMSO): 0.8 (t, 3 H, CH₃), 1.2 (m, 14 H, CH₂), 1.35 (s, 24 H, CH₃), 1.8 (m, 2 H, CH₂), 4.4 (m, 2 H, CH₂), 7.75 (s, 2 H, ═CH).

Precursor Compound 2 (R=hexyl):

yield: 75%; Fp=205° C. (toluene/methanol); 1H-NMR (DMSO): 0.8 (t, 3 H, CH₃), 1.2 (m, 6 H, CH₂), 1.35 (s, 24 H, CH₃), 1.75 (m, 2 H, CH₂), 4.4 (m, 2 H, CH₂), 7.75 (s, 2 H, ═CH).

### EXAMPLE 2

2,6-Dibromo-4-decyl-4H-dithieno[3,2-b:2′,3′-d]pyrrole precursor was produced as follows:

To a solution of 2 mmol N-alkyldithienopyrrole in 20 ml chloroform was added a solution of 4 mmol N-bromosuccinimide in 3 ml N,N-dimethylformamide at 0° C. over 3 hrs. After stirring for 1 hr at 0° C., 20 ml water were added and the layers (water layer and organic layer; organic layer=chloroform) were separated. The organic layer was evaporated in vacuum and the residue was dissolved in 20 ml n-hexane. 0.5 g charcoal was added, stirred for 10 min and filtered. The solvent was removed in vacuum. The product was used without further purification.

General procedure:

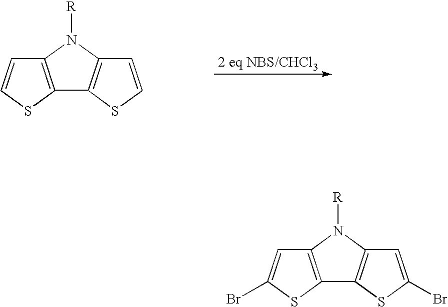

Compound 3 (R=decyl): yield: 90%; purity>95% (GC-MS)

### EXAMPLE 3

Copolymers via Stille-coupling:

Two dithienopyrrole-containing copolymers were produced via Stille-coupling as follows:

To a solution of 2 mmol N-alkyldithienopyrrol in 20 ml tetrahydrofurane was added 4.4 mmol n-butyllithium (1.6 M solution in n-hexane) at −78° C. After stirring for 3 hrs. at −78° C. the mixture was warmed to 0° C., stirred for 15 min and cooled down again to −78° C. 4.4 mmol tributyl-tin chloride was added and the mixture was allowed to warm to 20° C. overnight. 2 mmol of compound Br-E-Br (as indicated below) and 0.1 mmol of (Ph₃P)₂PdCl₂. was added and the mixture was heated under reflux for 20 hrs. After cooling to 20° C., 20 ml water was added and the polymer was isolated by suction filtration or removal of the solvent and purified by extraction with organic solvents.

General procedure:

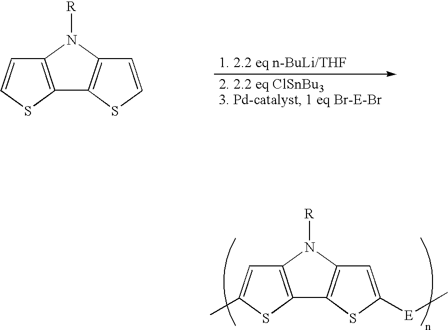

Compound 4: (4-decyl-4H-dithieno[3,2-b:2′,3′-d]pyrrole-2,6-diyl)-bis-(4,4,5,5-tetramethyl-1,3,2-dioxaborolane), polymer with 5,8-dibromo-2,3-diphenylquinoxaline, obtained by reaction of compounds 1 and Br-E-Br 1:

Molecular Weight (MW)>10000; absorbance maximum (Film): 690 nm; absorbance maximum (THF): 630 nm. Wherein Br-E-Br 1=

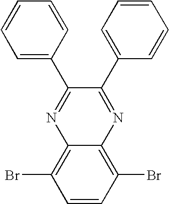

Compound 5: (4-decyl-4H-dithieno[3,2-b:2′,3′-d]pyrrole-2,6-diyl)-bis-(4,4,5,5-tetramethyl-1,3,2-dioxaborolane), polymer with 5,8-bis(5-bromo-2-thienyl)-2,3-diphenylquinoxaline, obtained by reaction of compounds 1 and Br-E-Br 2:

MW>10000; absorbance maximum (N-methylpyrrolidone (NMP)): 630 nm.

Wherein Br-E-Br 2=

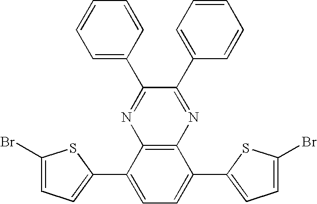

### EXAMPLE 4

Copolymers via Suzuki-coupling:

Three dithienopyrrole-containing copolymers were produced via Suzuki-coupling as follows:

To a solution of 2 mmol precursor 1 in 20 ml tetrahydrofurane was added 2 mmol of compound Br-E-Br and 0.1 mmol of (Ph₃P)₄Pd (0) . After stirring for 5 min, a solution of 8 mmol potassium carbonate in 5 ml water was added. The mixture was heated under reflux for 50 hrs. 0.2 mmol benzeneboronic acid were added and reflux was continued for 8 hrs. 0.4 mmol bromobenzene were added and reflux was continued for 8 hrs. After cooling to 20° C., the polymer was isolated by suction filtration or removal of the solvent and purified by extraction with organic solvents.

General procedure:

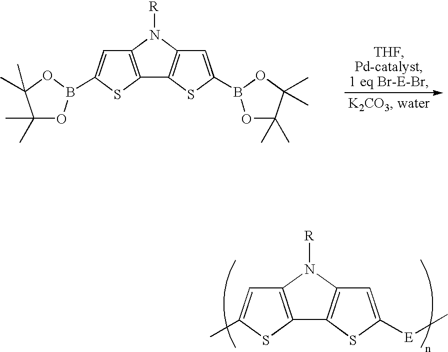

Compound 6: (4-decyl-4H-dithieno[3,2-b:2′,3′-d]pyrrole-2,6-diyl)-bis-(4,4,5,5-tetramethyl-1,3,2-dioxaborolane), polymer with 5,8-bis(5-bromo-2-thienyl)-2,3-diphenylquinoxaline, benzeneboronic acid and bromobenzene, obtained by reaction of compounds 1 and Br-E-Br 2:

MW>10000; absorbance maximum (NMP): 630 nm.

Compound 7: (4-decyl-4H-dithieno[3,2-b:2′,3′-d]pyrrole-2,6-diyl)-bis-(4,4,5,5-tetramethyl-1,3,2-dioxaborolane), polymer with 5,8-bis(5-bromo-3-hexyl-2-thienyl)-2,3-diphenylquinoxaline, benzeneboronic acid and bromobenzene, obtained by reaction of compounds 1 and Br-E-Br 3:

MW=26600; absorbance maximum (Film): 560 nm; absorbance maximum (Dichloromethane (DCM)): 480 nm. Wherein Br-E-Br 3=

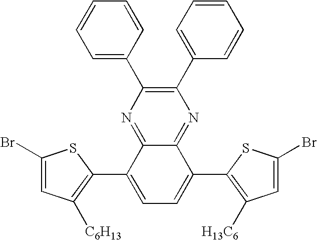

Compound 8: (4-decyl-4H-dithieno[3,2-b:2′,3′-d]pyrrole-2,6-diyl)-bis-(4,4,5,5-tetramethyl-1,3,2-dioxaborolane), polymer with 5,8-bis(5-bromo-3-hexyl-2-thienyl)-2,1,3-benzothiadiazole, benzeneboronic acid and bromobenzene, obtained by reaction of compounds 1 and Br-E-Br 4:

MW=7300; absorbance maximum (Film): 560 nm; absorbance maximum (DCM): 520 nm. Wherein Br-E-Br 4=

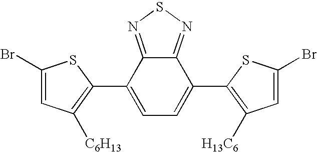

### EXAMPLE 5

One copolymer was produced via Suzuki-coupling as follows:

To a solution of 2 mmol 9,9-dioctylfluorene-2,7-bis-(trimethylenborate) (commercially available from Sigma-Aldrich Co. of St. Louis, Mo.) in 20 ml toluene was added 2 mmol of compound 3 and 0.1 mmol of (Ph₃P)₂PdCl₂. After stirring for 5 min, a solution of 8 mmol potassium carbonate in 5 ml water was added. The mixture was heated under reflux for 40 hrs. 10 ml 1.0 M hydrochloric acid were added and reflux was continued for 1 hr. After cooling to 20° C., the polymer was isolated by suction filtration and purified by extraction with organic solvents.

Compound 9: 9,9-dioctylfluorene-2,7-bis-(trimethylenborate), polymer with 2,6-dibromo-4-decyl-4H-dithieno[3,2-b:2′,3′-d]pyrrole: MW=34000; absorbance maximum (Film): 475, 500 nm; absorbance maximum (THF): 490 nm

### EXAMPLE 6

Four copolymers were produced via Suzuki-coupling as follows:

To a solution of 2 mmol precursor 2 in 20 ml tetrahydrofurane was added 2 mmol of compound Br-E-Br and 0.1 mmol of (Ph₃P)₂PdCl₂. After stirring for 5 min, a solution of 8 mmol potassium carbonate in 5 ml water was added. The mixture was heated under reflux for 50 hrs. 0.2 mmol thiophene-2-boronic acid were added and reflux was continued for 8 hrs. 0.4 mmol 2-bromothiophene were added and reflux was continued for 8 hrs. After cooling to 20° C., the polymer was isolated by suction filtration or removal of the solvent and purified by extraction with organic solvents or recrystallization.

General procedure:

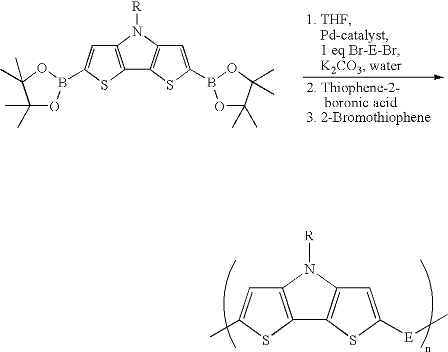

Compound 10: (4-hexyl-4H-dithieno[3,2-b:2′,3′-d]pyrrole-2,6-diyl)-bis-(4,4,5,5-tetramethyl-1,3,2-dioxaborolane), polymer with 5,7-bis(5-bromo-2-thienyl)-2,3-bis(4-octylphenyl)-thieno[3,4-b]pyrazine, thiophene-2-boronic acid and 2-bromothiophene, obtained by reaction of compounds 2 and Br-E-Br 5:

MW=>10000; absorbance maximum (toluene): 700 nm. Wherein Br-E-Br 5=

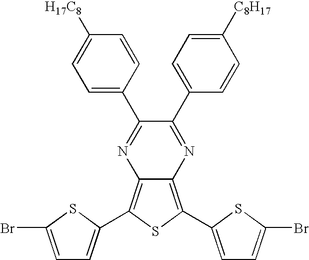

Compound 11: (4-hexyl-4H-dithieno[3,2-b:2′,3′-d]pyrrole-2,6-diyl)-bis-(4,4,5,5-tetramethyl-1,3,2-dioxaborolane), polymer with 5,5′-dibromo-3,3′-didecyl-2,2′-bithiophene, thiophene-2-boronic acid and 2-bromothiophene, obtained by reaction of compounds 2 and Br-E-Br 6: MW=13400; absorbance maximum (film): 470 nm; absorbance maximum (toluene): 468 nm. Wherein Br-E-Br 6=

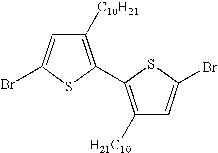

Compound 12: (4-hexyl-4H-dithieno[3,2-b:2′,3′-d]pyrrole-2,6-diyl)-bis-(4,4,5,5-tetramethyl-1,3,2-dioxaborolane), polymer with 5,5′-dibromo-3,3′-dihexyl-2,2′-bithiophene, thiophene-2-boronic acid and 2-bromothiophene, obtained by reaction of compounds 2 and Br-E-Br 7:MW=10300; absorbance maximum (film): 475 nm; absorbance maximum (toluene): 468 nm. Wherein Br-E-Br 7=

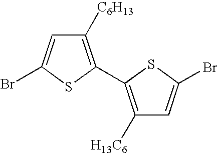

Compound 13: (4-hexyl-4H-dithieno[3,2-b:2′,3′-d]pyrrole-2,6-diyl)-bis-(4,4,5,5-tetramethyl-1,3,2-dioxaborolane), polymer with 5,5′-dibromo-4,4′-dihexyl-2,2′-bithiophene, thiophene-2-boronic acid and 2-bromothiophene, obtained by reaction of compounds 2 and Br-E-Br 8: MW=9500; absorbance maximum (film): 530 nm; absorbance maximum (toluene): 480 nm. Wherein Br-E-Br 8=

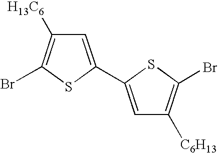

### EXAMPLE 7

Two copolymers were produced via Suzuki-coupling as follows:

To a solution of 2 mmol precursor 2 in 20 ml 2-methyltetrahydrofurane was added 2 mmol of compound Br-E-Br and 0.1 mmol of (Ph₃P)₂PdCl₂. After stirring for 5 min a solution of 8 mmol potassium carbonate in 5 ml water was added. The mixture was heated under reflux for 40 hrs. 0.2 mmol 5-bromothiophene-2-carboxylic acid were added and reflux was continued for 8 hrs. After cooling to 20° C., the polymer was isolated by suction filtration or removal of the solvent and purified by extraction with organic solvents or recrystallization.

General procedure:

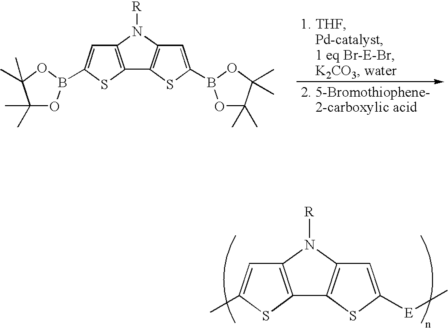

Compound 14: (4-decyl-4H-dithieno[3,2-b:2′,3′-d]pyrrole-2,6-diyl)-bis-(4,4,5,5-tetramethyl-1,3,2-dioxaborolane), polymer with 2,5-dibromothiophene and 5-bromothiophene-2-carboxylic acid, obtained by reaction of compounds 1 and Br-E-Br 9:

MW=>10000; absorbance maximum (CDCl₃): 535 nm.

Wherein Br-E-Br 9=

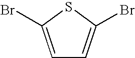

Compound 15: (4-hexyl-4H-dithieno[3,2-b:2′,3′-d]pyrrole-2,6-diyl)-bis-(4,4,5,5-tetramethyl-1,3,2-dioxaborolane), polymer with 5,5′-dibromo-4,4′-dibutyl-2,2′-bithiophene and 5-bromothiophene-2-carboxylic acid, obtained by reaction of compounds 2 and Br-E-Br 10:

MW=9200; absorbance maximum (toluene): 484 nm. Wherein Br-E-Br 10=

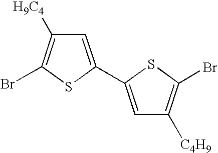

### EXAMPLE 8

One copolymer was produced via Suzuki-coupling as follows:

To a solution of 2 mmol precursor 2 in 20 ml tetrahydrofurane was added 2 mmol of compound Br-E-Br and 0.1 mmol of (Ph₃P)₄Pd (0). After stirring for 5 min a solution of 8 mmol potassium carbonate in 5 ml water was added. The mixture was heated under reflux for 40 hrs. 0.2 mmol precursor 2 were added and reflux was continued for 8 hrs. 0.5 mmol 5-bromothiophene-2-carboxylic acid were added and reflux was continued for 8 hrs. After cooling to 20° C., the polymer was isolated by suction filtration or removal of the solvent and purified by extraction with organic solvents or recrystallization.

General procedure:

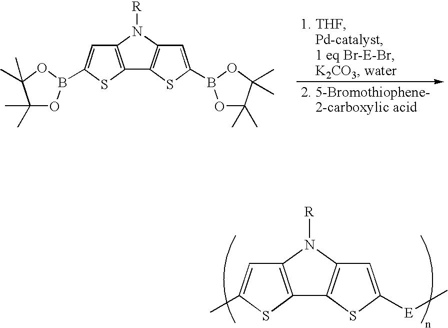

Compound 16: (4-hexyl-4H-dithieno[3,2-b:2′,3′-d]pyrrole-2,6-diyl)-bis-(4,4,5,5-tetramethyl-1,3,2-dioxaborolane), polymer with 5,5′-dibromo-3,3′-dibutyl-2,2′-bithiophene and 5-bromothiophene-2-carboxylic acid, obtained by reaction of compounds 2 and Br-E-Br 11: MW=8500; absorbance maximum (film): 480 nm; absorbance maximum (toluene): 468 nm. Wherein Br-E-Br 11=

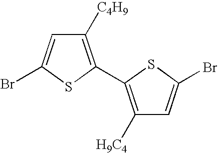

### EXAMPLE 9

Oxidation with iodine:

To a solution of the copolymer in toluene, a solution of iodine (0.01-4 eq iodine per monomer unit) in toluene was added. The mixture was stirred at 25° C. for 2 hrs. The solution was measured by UV/VIS—spectroscopy.

UV/VIS-spectra of compound 11 (concentration: 14.2 mg compound 11/1000 ml toluene) with different quantities of iodine, yielding the results summarized in Table 1:

TABLE 1

| | | absorbance at | absorbance at |
|---|---|---|---|
| solution/ | iodine in | λmax app. 468 nm | λmax app. 795 nm |
| curve | mol % I | (reduced state) | (oxidized state) |
| 1 | 0 | 0.94 | 0 |
| 2 | 1 | 0.93 | <0.01 |
| 3 | 5 | 0.92 | <0.01 |
| 4 | 10 | 0.91 | 0.01 |
| 5 | 20 | 0.89 | 0.02 |
| 6 | 40 | 0.84 | 0.04 |
| 7 | 100 | 0.65 | 0.12 |
| 8 | 200 | 0.49 | 0.19 |
| 9 | 400 | 0.38 | 0.26 |

UV/VIS-spectra of compound 12 (concentration: 22.5 mg compound 12/1000 ml toluene) with different quantities of iodine, yielding the results summarized in Table 2:

TABLE 2

| | | absorbance at | absorbance at |
|---|---|---|---|
| solution/ | iodine in | λmax app. 468 nm | λmax app. 795 nm |
| curve | mol % I | (reduced state) | (oxidized state) |
| 1 | 0 | 1.60 | 0 |
| 2 | 1 | 1.59 | <0.01 |
| 3 | 5 | 1.57 | 0.01 |
| 4 | 10 | 1.55 | 0.02 |
| 5 | 20 | 1.47 | 0.05 |
| 6 | 50 | 1.26 | 0.17 |
| 7 | 100 | 0.97 | 0.30 |
| 8 | 200 | 0.66 | 0.37 |
| 9 | 400 | 0.54 | 0.42 |

### EXAMPLE 10

Oxidation with iodine and isolation:

To a solution of 250 mg compound 11 in 20 ml toluene a solution of 0.5 mg iodine in 20 ml toluene was added. The mixture was stirred at 20-25° C. for 2 hrs. The solvent was removed and the product was dried in vacuum.

Compound 17: (4-hexyl-4H-dithieno[3,2-b:2′,3′-d]pyrrole-2,6-diyl)-bis-(4,4,5,5-tetramethyl-1,3,2-dioxaborolane), polymer with 5,5′-dibromo-3,3′-didecyl-2,2′-bithiophene, thiophene-2-boronic acid and 2-bromothiophene, oxidation product with iodine (500: 1 w/w); absorbance maximum (toluene): 468 nm

To a solution of 250 mg compound 11 in 20 ml toluene a solution of 25 mg iodine in 20 ml toluene was added. The mixture was stirred at 20-25° C. for 2 hrs. The solvent was removed and the product was dried in vacuum.

Compound 18: (4-hexyl-4H-dithieno[3,2-b:2′,3′-d]pyrrole-2,6-diyl)-bis-(4,4,5,5-tetramethyl-1,3,2-dioxaborolane), polymer with 5,5′-dibromo-3,3′-didecyl-2,2′-bithiophene, thiophene-2-boronic acid and 2-bromothiophene, oxidation product with iodine (10: 1 w/w); absorbance maxima (chloroform): 468 and 800 nm

### EXAMPLE 11 (COMPARATIVE)

The Suzuki-coupling process of Example 4 was conducted to react 9,9-dioctylfluorene-2,7-bis-(trimethylenborate) with compound Br-E-Br 4, producing compound 19: 9,9-dioctylfluorene-2,7-bis-(trimethylenborate), polymer with 5,8-bis(5-bromo-3-hexyl-2-thienyl)-2,1,3-benzothiadiazole, benzeneboronic acid and bromobenzene.

MW=13300; absorbance maximum (Film): 480 nm; absorbance maximum (DCM): 460 nm

### EXAMPLE 12 (COMPARATIVE)

The Suzuki-coupling process of Example 4 was conducted to react 9,9-dioctylfluorene-2,7-bis-(trimethylenborate) with compound Br-E-Br 2, producing compound 20: 9,9-dioctylfluorene-2,7-bis-(trimethylenborate), polymer with 5,8-bis(5-bromo-2-thienyl)-2,3-diphenylquinoxaline, benzeneboronic acid and bromobenzene.

MW=3100; absorbance maximum (Film): 550 nm; absorbance maximum (DCM): 530 nm

### EXAMPLE 13 (COMPARATIVE)

The Suzuki-coupling process of Example 4 was conducted to react 9,9-dioctylfluorene-2,7-bis-(trimethylenborate) with compound Br-E-Br 3, producing compound 21: 9,9-dioctylfluorene-2,7-bis-(trimethylenborate), polymer with 5,8-bis(5-bromo-3-hexyl-2-thienyl)-2,3-diphenylquinoxaline, benzeneboronic acid and bromobenzene

MW=5300; absorbance maximum (Film): 450 nm; absorbance maximum (toluene): 440 nm

All of the experiments above were carried out under nitrogen. Polymerizations and brominations were carried out in the dark. Dry solvents were used and the Pd-catalyst was either (Ph₃P)₂PdCl₂ or (Ph₃P)₄Pd (0). N-alkyldithienopyrrole was produced as described in Koeckelberghs, G. et al. Tetrahedron 2005, 61, 687-691, which is incorporated herein by reference.

It is demonstrated with these experiments that dithienopyrrole can be used as monomer for the manufacturing of copolymers. The comparison compounds were manufactured to demonstrate the electron donor effect of the dithienopyrrole compared to the fluorine. By replacing the fluorine with dithienopyrrole, a shift of 80-110 nm to longer wavelength was observed for the corresponding copolymers. Dithienopyrrole is therefore a useful monomer for manufacturing of low band gap semiconductors.

While the present invention has been particularly shown and described with reference to preferred embodiments, it will be readily appreciated by those of ordinary skill in the art that various changes and modifications may be made without departing from the spirit and scope of the invention. It is intended that the claims be interpreted to cover the disclosed embodiment, those alternatives which have been discussed above and all equivalents thereto. Additionally, while the methods particularly exemplified herein are preferred for the formation of the copolymers of the invention, it should be understood that other methods commonly known in the art may be alternately utilized.

What is claimed is:

1. A dithienopyrrole-containing copolymer having the formula:
Y-(D_{f})-[(A)-(D)]ₙ-(A_{g})-Z
wherein D comprises a first monomer radical having the structure: 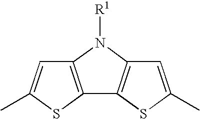
wherein R¹ comprises a C₁ to C₂₀ alkyl group, a C₁ to C₂₀ heteroalkyl group, a C₁ to C₂₀ F-alkyl group, a C₁ to C₂₀ O-alkyl group, a C₁ to C₂₀ S-alkyl group, a C₆ to C₂₀ aryl group or a C₁ to C₂₀ heteroaryl group;
wherein A comprises a second monomer radical different from D which forms a copolymer with D; wherein f and g are 0 or 1;
Y and Z independently comprise hydrogen, a halogen, a C₆ to C₂₀ aryl, a C₁ to C₂₀ heteroaryl, a C₁ to C₂₀ alkyl, a functional group comprising B(OR)(OR′), —COOR, —CONRR′, —CN, —OR, —OCOR, —SCOR, —SCSR, —CSSR, —SO₃R, —SO₃NRR′, —COR, OSO₂R, OSO₃R, —CSR, —NRR′, —NRR′R″⁺, 13 NRCOR′, —NO, —NO₂, —NCO, —NCS, or a C₆ to C₂₀ aryl with one or more independent functional groups, a C₁ to C₂₀ heteroaryl with one or more independent functional groups, or a C₁ to C₂₀ alkyl with one or more independent functional groups; wherein R, R′ and R″ independently comprise hydrogen, a C₁ to C₂₀ alkyl group, a C₁ to C₂₀ heteroalkyl group, a C₁ to C₂₀ F-alkyl group, a C₆ to C₂₀ aryl group; or a C₁ to C₂₀ heteroaryl group or a counterion forming a salt; and
wherein n is about 1 to about 100.

2. The dithienopyrrole-containing copolymer of claim 1 wherein A comprises an electron acceptor monomer radical of the structure: 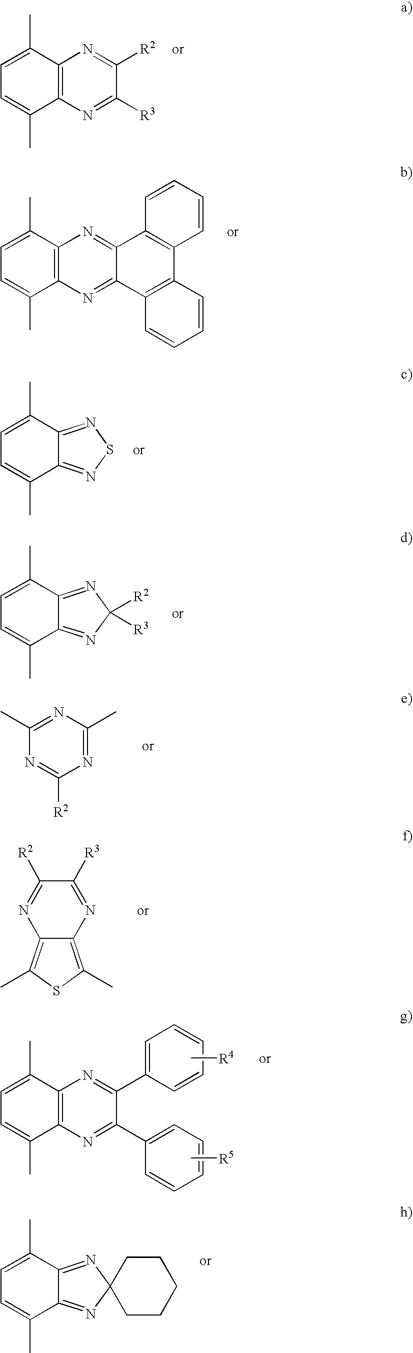 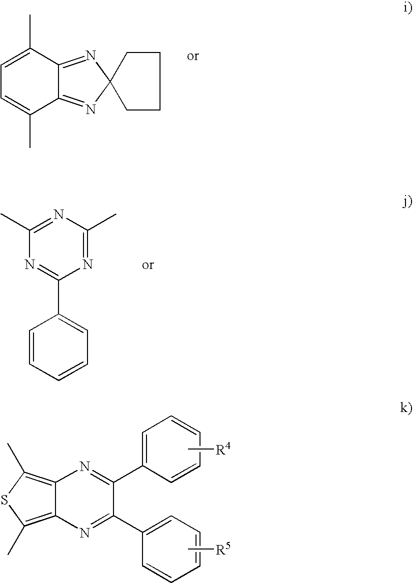
wherein R², R³, R⁴ and R⁵ independently comprise hydrogen, a C₁ to C₂₀ alkyl group, a C₁ to C₂₀ heteroalkyl group, a C₁ to C₂₀ cycloalkyl group, a C₁ to C₂₀ F-alkyl group, a C₁ to C₂₀ O-alkyl group, a C₁ to C₂₀ S-alkyl group, a C₆ to C₂₀ aryl group, a C₁ to C₂₀ heteroaryl group, a C₁ to C₂₀ alkyl-substituted C₆ to C₂₀ aryl group or a C₁ to C₂₀ alkoxy-substituted C₆ to C₂₀ aryl group.

3. An article comprising the dithienopyrrole-containing copolymer of claim 1.

4. A dithienopyrrole-containing copolymer comprising the reaction product of the dithienopyrrole-containing copolymer of claim 1 with an oxidizing agent, producing a dithienopyrrole-containing copolymer having the formula:
$$Y - ( {D}_{f} ) - {[ ( A ) - ( D ) ]}_{n}^{k ⊕} - ( {A}_{g} ) - Z \cdot \frac{k}{t} {X}^{t ⊖}$$
wherein X is an anion, wherein t is 1 to 4 and wherein k is 1 to 100.

5. A dithienopyrrole-containing copolymer having the formula:
V-(Tₗ)ₐ-(D)_{b}-(Tₘ)_{c}-[(Aₚ)-(Tₗ)-(D)-(Tₘ)]ₙ-(Aₚ)_{d}-(Tₗ)ₑ-W
wherein D comprises a first monomer radical having the structure: 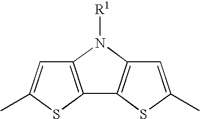
wherein R¹ comprises a C₁ to C₂₀ alkyl group, a C₁ to C₂₀ heteroalkyl group, a C₁ to C₂₀ F-alkyl group, a C₁ to C₂₀ O-alkyl group, a C₁ to C₂₀ S-alkyl group, a C₆ to C₂₀ aryl group or a C₁ to C₂₀ heteroaryl group;
wherein A comprises a second monomer radical different from D which forms a copolymer with D;
wherein each T independently comprises an unsubstituted thiophene monomer radical, a substituted thiophene monomer radical, an unsubstituted thiophene oligomer radical or a substituted thiophene oligomer radical; said substituents comprising one or more hydrogens, C₁ to C₂₀ alkyl groups, C₁ to C₂₀ heteroalkyl groups, C₁ to C₂₀ F-alkyl groups, C₁ to C₂₀ O-alkyl groups, C₁ to C₂₀ S-alkyl groups, C₆ to C₂₀ aryl groups, C₁ to C₂₀ heteroaryl groups or a combination thereof;
V and W independently comprise hydrogen, a halogen, a C₆ to C₂₀ aryl, a C₁ to C₂₀ heteroaryl, a C₁ to C₂₀ alkyl, a functional group comprising B(OR)(OR′), —COOR, —CONRR′, —CN, —OR, —OCOR, —SCOR, —SCSR, —CSSR, —SO₃R, —SO₃NRR′, —COR, OSO₂R, OSO₃R, —CSR, —NRR′, —NRR′R″⁺, —NRCOR′, —NO, —NO₂, —NCO, —NCS, or a C₆ to C₂₀ aryl with one or more independent functional groups, a C₁ to C₂₀ heteroaryl with one or more independent functional groups, or a C₁ to C₂₀ alkyl with one or more independent functional groups; wherein R, R′ and R″ independently comprise hydrogen, a C₁ to C₂₀ alkyl group, a C₁ to C₂₀ heteroalkyl group, a C₁ to C₂₀ F-alkyl group, a C₆ to C₂₀ aryl group; or a C₁ to C₂₀ heteroaryl group or a counterion forming a salt;
wherein a, b, c, d and e are 0 or 1; wherein 1, m and p are 0 or 1 and l+m+p=1 or 2 or 3; and wherein n is about 1 to about 100.

6. The dithienopyrrole-containing copolymer of claim 5 wherein each T independently comprises an unsubstituted thiophene monomer radical, a substituted thiophene monomer radical or a substituted thiophene oligomer radical, said substituents comprising one or more hydrogens, C₁ to C₂₀ alkyl groups, C₁ to C₂₀ heteroalkyl groups, C₁ to C₂₀ F-alkyl groups, C₁ to C₂₀ O-alkyl groups, C₁ to C₂₀ S-alkyl groups, C₆ to C₂₀ aryl groups, C₁ to C₂₀ heteroaryl groups or a combination thereof.

7. The dithienopyrrole-containing copolymer of claim 5 wherein each T independently comprises a substituted thiophene monomer radical having the structure: 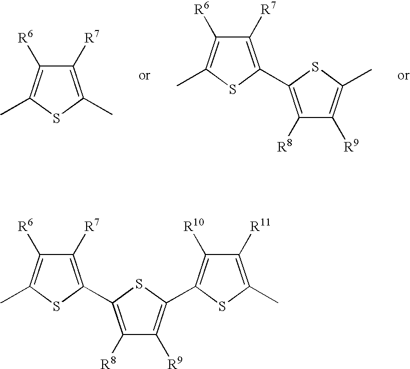
wherein R⁶, R⁷, R⁸, R⁹, R¹⁰ and R¹¹ independently comprise hydrogen, a C₁ to C₂₀ alkyl group, a C₁ to C₂₀ heteroalkyl group, a C₁ to C₂₀ F-alkyl group, a C₁ to C₂₀ O-alkyl group, a C₁ to C₂₀ S-alkyl group, a C₆ to C₂₀ aryl group or a C₁ to C₂₀ heteroaryl group

8. The dithienopyrrole-containing copolymer of claim 5 wherein A comprises an electron acceptor monomer radical of the structure: 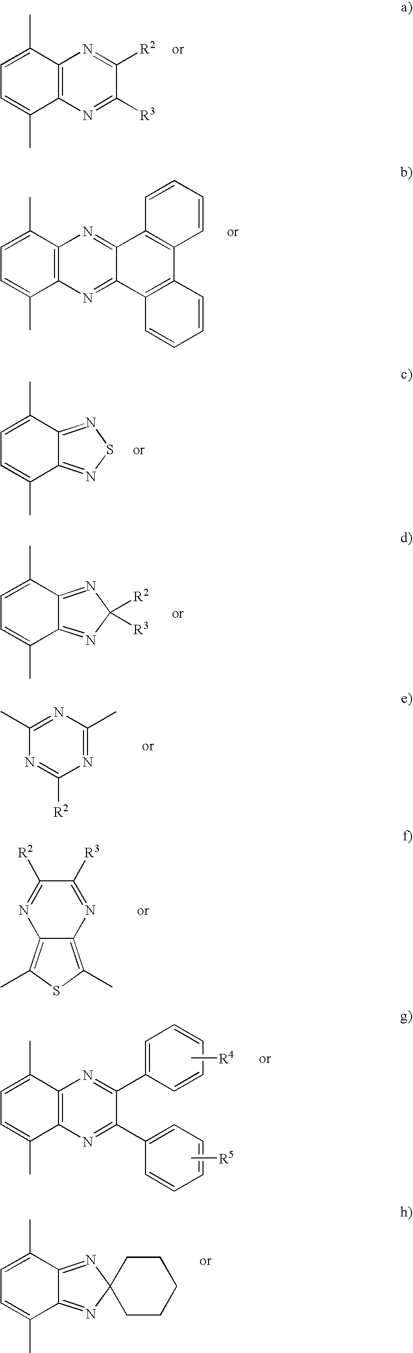 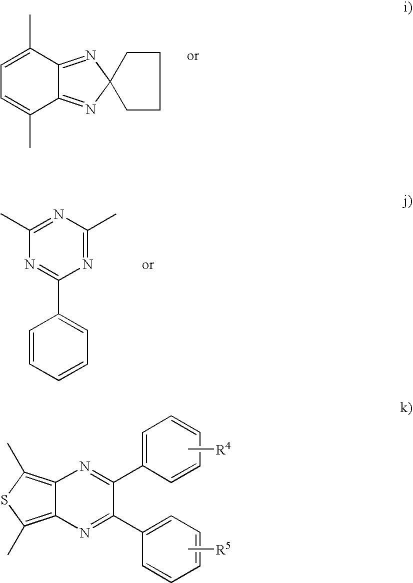
wherein R², R³, R⁴ and R⁵ independently comprise hydrogen, a C₁ to C₂₀ alkyl group, a C₁ to C₂₀ heteroalkyl group, a C₁ to C₂₀ cycloalkyl group, a C₁ to C₂₀ F-alkyl group, a C₁ to C₂₀ O-alkyl group, a C₁ to C₂₀ S-alkyl group, a C₆ to C₂₀ aryl group, a C₁ to C₂₀ heteroaryl group, a C₁ to C₂₀ alkyl-substituted C₆ to C₂₀ aryl group or a C₁ to C₂₀ alkoxy-substituted C₆ to C₂₀ aryl group.

9. An article comprising the dithienopyrrole-containing copolymer of claim 5.

10. A dithienopyrrole-containing copolymer comprising the reaction product of the dithienopyrrole-containing copolymer of claim 5 with an oxidizing agent to produce a dithienopyrrole-containing copolymer having the formula:
$$V - {( {T}_{l} )}_{a} - {( D )}_{b} - {( {T}_{m} )}_{c} - {[ ( {A}_{p} ) - ( {T}_{l} ) - ( D ) - ( {T}_{m} ) ]}_{n}^{k ⊕} - {( {A}_{p} )}_{d} - {( {T}_{l} )}_{e} - W \cdot \frac{k}{t} {X}^{t ⊖}$$
wherein X is an anion, wherein t is 1 to 4 and wherein k is 1 to 100.

11. A method for forming a dithienopyrrole-containing copolymer having the formula:
Y-(D_{f})-[(A)-(D)]ₙ-(A_{g})-Z
the process comprising:
a) providing a first monomer X¹-D-X², wherein D is a first monomer radical having the structure: 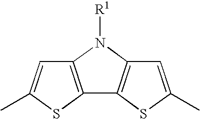
wherein R¹ comprises a C₁ to C₂₀ alkyl group, a C₁ to C₂₀ heteroalkyl group, a C₁ to C₂₀ F-alkyl group, a C₁ to C₂₀ O-alkyl group, a C₁ to C₂₀ S-alkyl group, a C₆ to C₂₀ aryl group or a C₁ to C₂₀ heteroaryl group; and wherein X¹ and X² independently comprise hydrogen, a halogen, a metal leaving group or a non-halogen electron withdrawing group;
b) if X¹ and X² are hydrogen, reacting the first monomer with at least one first reagent, thereby forming an intermediate reaction product, then (c)(I); if X¹ and X² are not hydrogen, then (c)(II);
c) I) if X¹and X² are hydrogen, reacting the intermediate reaction product with a second monomer radical, A, in the presence of a polymerization catalyst to form a dithienopyrrole-containing copolymer intermediate;
or
II) if neither X¹nor X² are hydrogen, reacting the first monomer with A in the presence of a polymerization catalyst to form a dithienopyrrole-containing copolymer intermediate; and
d) reacting the dithienopyrrole-containing copolymer intermediate with a reaction terminating agent such that Y and Z independently comprise hydrogen, a halogen, a C₆ to C₂₀ aryl, a C₁ to C₂₀ heteroaryl, a C₁ to C₂₀ alkyl, a functional group comprising B(OR)(OR′), —COOR, —CONRR′, —CN, —OR, —OCOR, —SCOR, —SCSR, —CSSR, —SO₃R, —SO₃NRR′, —COR, OSO₂R, OSO₃R, —CSR, —NRR′, —NRR′R″⁺, —NRCOR′, —NO, —NO₂, —NCO, —NCS, or a C₆ to C₂₀ aryl with one or more independent functional groups, a C₁ to C₂₀ heteroaryl with one or more independent functional groups, or a C₁ to C₂₀ alkyl with one or more independent functional groups; wherein R, R′ and R″ independently comprise hydrogen, a C₁ to C₂₀ alkyl group, a C₁ to C₂₀ heteroalkyl group, a C₁ to C₂₀ F-alkyl group, a C₆ to C₂₀ aryl group; or a C₁ to C₂₀ heteroaryl group or a counterion forming a salt; and
wherein f and g are 0 or 1; wherein A is different than said first monomer radical and forms a copolymer with D; and wherein n is about 1 to about 100.

12. The method of claim 11 wherein X¹ and X² are metal leaving groups and independently comprise lithium, sodium, potassium, zinc, magnesium, tin, boron containing groups or a combination thereof; or wherein X¹ and X² are non-halogen electron withdrawing groups and independently comprise OR, NR ₂, CN, OC(O)R or OSO₂R wherein R comprises a C₁ to C₂₀ alkyl group, a C₁ to C₂₀ heteroalkyl group, a C₁ to C₂₀ F-alkyl group, a C₁ to C₂₀ O-alkyl group, a C₁ to C₂₀ S-alkyl group, a C₆ to C₂₀ aryl group or a C₁ to C₂₀ heteroaryl group.

13. The method of claim 11 wherein second monomer A is monosubstituted or disubstituted with one or more halogens, metal leaving groups or non-halogen electron withdrawing groups.

14. The method of claim 11 wherein the polymerization catalyst comprises [1,3-bis(diphenylphosphino)propane]dichloronickel(II), nickel(II) acetylacetonate, 1,2-bis(diphenylphosphino)ethane nickel(II) chloride, dichlorobis(triphenylphosphine) palladium (II), tetrakis(triphenylphosphine) palladium (0), complexes of palladium(II) chloride and tri-tert-butylphosphine, complexes of palladium(II) chloride and 2,2′-bis(diphenylphosphino)-1,1′-binaphthalene, complexes of palladium(II) acetate and tri-tert-butylphosphine, or complexes of or palladium(II) acetate and 2,2′-bis(diphenylphosphino)-1,1-binaphthalene, complexes of nickel (II) acetylacetonate and tri-tert-butylphosphine, triadamantylphosphine, 1,3-bis(2,4,6-trimethylphenyl)imidazolium chloride, 1,3-bis(2,6-diisopropylphenyl), 1,3-bis(2,6-diisopropylphenyl)imidazolium chloride, 1,3,4-triphenyl-4,5-dihydro-1H-1,2,4-triazol-5-ylidene, 1,3-diadamantyl-imidazolium chloride, 1,3-bis(2,4,6-trimethylphenyl)-imidazolidinium chloride, 1,3-bis(2,6-diisopropylphenyl)-imidazolidinium chloride or suspensions or combinations thereof.

15. The method of claim 11 wherein said first reagent comprises a Grignard reagent, an organostannane, an organolithium group, an organosodium group, an organopotassium group, an organozinc group, an organoboronic acid, an organosilane or a combination thereof.

16. The method of claim 11 wherein step d) comprises
I) reacting the dithienopyrrole-containing copolymer intermediate with a reaction terminating agent comprising compound Y—X³ and/or compound Z-X⁴ in the presence of a polymerization catalyst for Y and Z to be a C₆ to C₂₀ aryl, a C₁ to C₂₀ heteroaryl, a C₁ to C₂₀ alkyl, a C₆ to C₂₀ arylcarboxylic acid, a C₁ to C₂₀ heteroarylcarboxylic acid, wherein X³ and X⁴ independently comprise a halogen, a metal leaving group or a non-halogen electron withdrawing group; or
II) reacting the dithienopyrrole-containing copolymer intermediate with a reaction terminating agent comprising an acid, or water, or a combination of acid and water, for Y and Z to be hydrogen, a halogen, boronic acid, boronic ester.

17. A method for forming a dithienopyrrole-containing copolymer having the formula:
V-(Tₗ)ₐ-(D)_{b}-(Tₘ)_{c}-[(Aₚ)-(Tₗ)-(D)-(Tₘ)]ₙ-(Aₚ)_{d}-(Tₗ)ₑ-W
the method comprising:
a) I) reacting a first monomer having the formula X¹-D-X² with a second monomer having the formula Y¹-Tₗ-Aₚ-Tₘ-Y² in the presence of a polymerization catalyst to form a dithienopyrrole-containing copolymer intermediate;
or
II) reacting a first monomer having the formula X¹-Tₗ-D-Tₘ-X² with a second monomer having the formula Y¹-Aₚ-Y² in the presence of a polymerization catalyst to form a dithienopyrrole-containing copolymer intermediate;
or
III) reacting a first monomer having the formula X¹-T_{h′}-D-T_{h″}-X² with a second monomer having the formula Y¹-T_{j′}-Aₚ-T_{j″}-Y² in the presence of a polymerization catalyst to form a dithienopyrrole-containing copolymer intermediate; wherein Tₕ-Tⱼ=Tₗ and Tⱼ-Tₕ=Tₘ where Tₕ is either T_{h′} or T_{h″} and Tⱼ is either T_{j′} or T_{j″};
b) reacting the dithienopyrrole-containing copolymer intermediate with a reaction terminating agent such that V and W independently comprise hydrogen, a halogen, a C₆ to C₂₀ aryl, a C₁ to C₂₀ heteroaryl, a C₁ to C₂₀ alkyl, a functional group comprising B(OR)(OR′), —COOR, —CONRR′, —CN, —OR, —OCOR, —SCOR, —SCSR, —CSSR, —SO₃R, —SO₃NRR′, —COR, OSO₂R, OSO₃R, —CSR, —NRR′, —NRR′R″⁺, —NRCOR′, —NO, —NO₂, —NCO, —NCS, or a C₆ to C₂₀ aryl with one or more independent functional groups, a C₁ to C₂₀ heteroaryl with one or more independent functional groups, or a C₁ to C₂₀ alkyl with one or more independent functional groups; wherein R, R′ and R″ independently comprise hydrogen, a C₁ to C₂₀ alkyl group, a C₁ to C₂₀ heteroalkyl group, a C₁ to C₂₀ F-alkyl group, a C₆ to C₂₀ aryl group; or a C₁ to C₂₀ heteroaryl group or a counterion forming a salt;
wherein:
D is a first monomer radical having the structure: 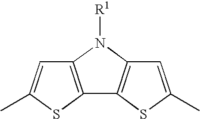
wherein R¹ comprises a C₁ to C₂₀ alkyl group, a C₁ to C₂₀ heteroalkyl group, a C₁ to C₂₀ F-alkyl group, a C₁ to C₂₀ O-alkyl group, a C₁ to C₂₀ S-alkyl group, a C₆ to C₂₀ aryl group or a C₁ to C₂₀ heteroaryl group;
wherein X¹, X², Y¹ and Y² independently comprise hydrogen, a halogen, a metal leaving group or a non-halogen electron withdrawing group;
wherein A is a second monomer radical different than D;
wherein each T independently comprises an unsubstituted thiophene monomer radical, a substituted thiophene monomer radical, an unsubstituted thiophene oligomer radical or a substituted thiophene oligomer radical; said substituents comprising one or more hydrogens, C₁ to C₂₀ alkyl groups, C₁ to C₂₀ heteroalkyl groups, C₁ to C₂₀ F-alkyl groups, C₁ to C₂₀ O-alkyl groups, C₁ to C₂₀ S-alkyl groups, C₆ to C₂₀ aryl groups, C₁ to C₂₀ heteroaryl groups or a combination thereof;
wherein a, b, c, d and e are 0 or 1; wherein l, m and p are 0 or 1 and l+m+p=1 or 2 or 3; and wherein n is about 1 to about 100.

18. The method of claim 17 wherein X¹ and X² or Y¹ and Y² are metal leaving groups and independently comprise lithium, sodium, potassium, zinc, magnesium, tin, boron containing groups or a combination thereof; or wherein X¹ and X² or Y¹ and U² are non-halogen electron withdrawing groups and independently comprise OR′, NR′₂, CN, OC(O)R′ or OSO₂R′ wherein R′ comprises a C₁ to C₂₀ alkyl group, a C₁ to C₂₀ heteroalkyl group, a C₁ to C₂₀ F-alkyl group, a C₁ to C₂₀ O-alkyl group, a C₁ to C₂₀ S-alkyl group, a C₆ to C₂₀ aryl group or a C₁ to C₂₀ heteroaryl group.

19. The method of claim 17 wherein the polymerization catalyst comprises [1,3-bis(diphenylphosphino)propane]dichloronickel(II), nickel (II) acetylacetonate, 1,2-bis(diphenylphosphino)ethane nickel(II) chloride, dichlorobis(triphenylphosphine)palladium (II), tetrakis(triphenylphosphine) palladium (0), complexes of palladium(II) chloride and tri-tert-butylphosphine, complexes of palladium(II) chloride and 2,2′-bis(diphenylphosphino)-1,1′-binaphthalene, complexes of palladium(II) acetate and tri-tert-butylphosphine, or complexes of or palladium(II) acetate and 2,2′-bis(diphenylphosphino)-1,1′-binaphthalene, complexes of nickel (II) acetylacetonate and tri-tert-butylphosphine, triadamantylphosphine, 1,3-bis(2,4,6-trimethylphenyl)imidazolium chloride, 1,3-bis(2,6-diisopropylphenyl), 1,3-bis(2,6-diisopropylphenyl)imidazolium chloride, 1,3,4-triphenyl-4,5-dihydro-1H-1,2,4-triazol-5-ylidene, 1,3-diadamantyl-imidazolium chloride, 1,3-bis(2,4,6-trimethylphenyl)-imidazolidinium chloride, 1,3-bis(2,6-diisopropylphenyl)-imidazolidinium chloride or suspensions or combinations thereof.

20. The method of claim 17 wherein step b) comprises
I) reacting the dithienopyrrole-containing copolymer intermediate with a reaction terminating agent comprising compound V—X³ and/or compound W—X⁴in the presence of a polymerization catalyst for V and W to be a C₆ to C₂₀ aryl, a C₁ to C₂₀ heteroaryl, a C₁ to C₂₀ alkyl, a C₆ to C₂₀ arylcarboxylic acid, a C₁ to C₂₀ heteroarylcarboxylic acid, wherein X³ and X⁴ independently comprise a halogen, a metal leaving group or a non-halogen electron withdrawing group; or
II) reacting the dithienopyrrole-containing copolymer intermediate with a reaction terminating agent comprising an acid, or water, or a combination of acid and water, for V and W to be hydrogen, a halogen, boronic acid, boronic ester.
